(19) United States
(12) Patent Application Publication
(10) Pub. No.: US 2008/0152936 A1
(43) Pub. Date: Jun. 26, 2008

(54) Methods For Mastering And Mastering Substrate

(75) Inventors: Erwin Rinaldo Meinders, Eindhoven (NL); Hinke Sijvert Petronella Bouwmans, Enschede (NL); Julien Jean Xavier De Loynes De Fumichon, Nantes (FR); Patrick Godefridus Jacobus Maria Peeters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,997

(22) PCT Filed: Jan. 2, 2006
(86) PCT No.: PCT/IB2006/050005

§ 371 Date: Jun. 28, 2007

(30) Foreign Application Priority Data
Jan. 6, 2005 (EP) 05100048.7
Mar. 29, 2005 (EP) 05102457.8
Jul. 13, 2005 (EP) 05106409.5

(51) Int. Cl. G11B 7/26; B44C 1/22; G11B 23/00

(52) U.S. Cl. 428/542.8; 216/38

(57) ABSTRACT

The present invention relates to a method for providing a high density relief structure in a recording stack (10) of a master substrate (12), particularly a master substrate (12) for making a stamper for the mass-fabrication of optical discs or a master substrate for creating a stamp for micro contact printing, the method comprising the following steps: —providing a recording stack (10) comprising a dielectric layer (14) and means (16, 18; 20) for supporting heat induced phase transitions within the dielectric layer (14); causing a heat induced phase transition in regions (22) of the dielectric layer (14) where pits (24) are to be formed by applying laser pulses; and removing the regions (22) of the dielectric layer (14), which have experienced a phase transition, by an etching process; or removing the regions (26) of the dielectric layer (14), which have not experienced a phase transition, by an etching process.

### FIELD OF THE INVENTION

The present invention relates to methods for providing a high density relief structure in a recording stack of a master substrate, particularly a master substrate for making a stamper for the mass-fabrication of optical discs or a master substrate for creating a stamp for micro contact printing. Furthermore, the invention relates to a master substrate for creating a high-density relief structure, particularly a master substrate for making a stamper for the mass-fabrication of optical discs or a master substrate for creating a stamp for micro contact printing. The invention also relates to methods for making stampers, optical discs, stamps, and microprints, respectively.

### BACKGROUND OF THE INVENTION

Relief structures that are manufactured on the basis of optical processes can, for example, be used as a stamper for the mass replication of read-only memory (ROM) and pre-grooved write-once (R) and rewriteable (RE) discs. The manufacturing of such a stamper, as used in a replication process, is known as mastering.

In conventional mastering, a thin photosensitive layer, spincoated on a glass substrate, is illuminated with a modulated focused laser beam. The modulation of the laser beam causes that some parts of the master substrate are being exposed by UV light while the intermediate areas in between the pits to be formed remain unexposed. While the disc rotates, and the focused laser beam is gradually pulled to the outer side of the disc, a spiral of alternating illuminated areas remains. In a second step, the exposed areas are being dissolved in a so-called development process to end up with physical holes inside the photo-resist layer. Alkaline liquids such as NaOH and KOH are used to dissolve the exposed areas. The structured surface of the master substrate is subsequently covered with a thin Ni layer. In a galvanic process, this sputter-deposited Ni layer is further grown to a thick manageable Ni substrate comprising the inverse pit structure. This Ni substrate with protruding bumps is separated from the master substrate and is called the stamper.

Phase-transition mastering (PTM) is a relatively new method to make high-density ROM and RE/R stampers for mass-fabrication of optical discs. Phase-transition materials can be transformed from the initial unwritten state to a different state via laser-induced heating. Heating of the recording stack can, for example, cause mixing, melting, amorphisation, phase-separation, decomposition, etc. One of the two phases, the initial or the written state, dissolves faster in acids or alkaline development liquids than the other phase does. In this way, a written data pattern can be transformed to a high-density relief structure with protruding bumps or pits. The patterned substrate can be used as stamper for the mass-fabrication of high-density optical discs or as stamp for micro-contact printing.

One of the challenges encountered with PTM is getting a good pit shape. Since this method is based on heating, the shape will roughly be determined by the temperature profile in the recording stack. The problem lies in the fact that most materials have either a rather high absorption rate (most metals) or a rather low absorption rate (most dielectrics). Materials with a high absorption rate have a bad absorption profile. While the heat is penetrating the stack, the high absorption rate gives a rapid decrease in power flux and thus a rapid decrease in the temperatures that are reached. This makes it hard to get the needed pit depth. Materials with a low absorption rate would have a very good pit shape, but getting the needed temperatures would require very large write powers. This makes it impossible to directly write dielectrics with conventional recorders.

Until now, these problems were overcome by using a mask stack. A selectively etchable material is placed on an etchable dielectric material. Selectively etchable means that only the written or the unwritten stage is etchable. Unselectively etchable means that both the written and the unwritten stage are etchable. In such a stack with mask layer, the mask layer is very thin and the absorption profile is not an issue. During etching the written part of the mask layer will dissolve, forming a mask. The dielectric under the mask will only be etched where the mask layer was etched. Underetching is unavoidable and the dissolution time is very critical.

It is therefore an object of the present invention to provide methods and master substrates of the type mentioned at the beginning that provide a good pit shape in connection with PTM.

### SUMMARY OF THE INVENTION

This object is solved by the features of the independent claims. Further developments and preferred embodiments of the invention are outlined in the dependent claims.

In accordance with a first aspect of the present invention, there is provided a method for providing a high density relief structure in a recording stack of a master substrate, particularly a master substrate for making a stamper for the mass-fabrication of optical discs or a master substrate for creating a stamp for micro contact printing, the method comprising the following steps:
providing a recording stack comprising a dielectric layer and means for supporting heat induced phase transitions within the dielectric layer;
causing a heat induced phase transition in regions of the dielectric layer where pits/bumps are to be formed by applying laser pulses; and
removing the regions of the dielectric layer, which have experienced a phase transition, by an etching process; or
removing the regions of the dielectric layer, which have not experienced a phase transition, by an etching process.

The means for supporting heat induced phase transitions within the dielectric layer comprise a heat absorption rate that, during the writing process, ensures a temperature profile in the recording stack that finally leads to a good pit shape.

With a first general embodiment of the method in accordance with the invention the means for supporting heat induced phase transitions within the dielectric layer comprise at least one absorption layer arranged above and/or below the dielectric layer. Thereby, the problem with too low absorption of the dielectric layer is circumvented by heating through conduction. The absorption layer can be selectively or unselectively etchable.

With a second general embodiment of the method in accordance with the invention the means for supporting heat induced phase transitions within the dielectric layer comprise a dopant doped into the dielectric layer. Thereby, the dielectric layer itself is made more absorbing in the wavelength range defined by the dopant. Changing the doping concentration makes the absorption adjustable. This way the absorption can, for example, be made high enough to make writing with use of existing lasers possible, but low enough to get a good pit shape. It is clear that the first and second embodiments can be combined advantageously.

With a third general embodiment of the method in accordance with the invention the means for supporting heat induced phase transitions within the dielectric layer comprise nanocrystals grown within the dielectric layer during an annealing process. At room temperature, for example, a ZnS—SiO₂ film contains tiny nanosized ZnS particles embedded in a SiO₂ matrix. The size of the nanocrystals is temperature dependent: increasing the temperature initiates a growing in size of the nanocrystals. This leads to a blue-shift in the light absorption range of ZnS—SiO₂. Scattering of blue light through the nano-composite material is assumed to be the main reason for this blue-shift. Preferred annealing temperatures vary between 600 and 900° C. For example the size of a ZnS—SiO₂ nanocrystal is about 2 nm at room temperature, and it increases to about 7.5 nm at 700° C. and to up to 50 nm at 800° C. Therefore, heating, for example, a thin layer of sputter-deposited ZnS—SiO₂ in an oven to 700° C. will cause a blue-shift, enabling the direct recording of marks. When such an annealing step is provided, at least in some cases additional absorption layers and/or doping are not necessary for recording marks in the ZnS—SiO₂ with a 405 nm laser beam recorder.

In cases where an absorption layer is used, the absorption layer is preferably made of a material selected from the following group: Ni, Cu, GeSbTe, SnGeSb, InGeSbTe, silicide forming materials like Cu—Si or Ni—Si, material compositions like nucleation dominated phase change materials. The needed thickness of the absorption layer depends on many of the material properties, like absorption rate, thermal conductivity, specific heat etc. For example, a Ni layer comprising a thickness of about 10 nm leads to good results.

For all embodiments of the invention it is preferred that the dielectric layer is a ZnS—SiO₂ layer. Also other dielectric materials, e.g. metal oxides such as Al₂O₃, Si₃N₄, ZrO₂, are possible.

The etchant used in the etching process is preferably selected from the following group: acid solutions like HNO₃, HCl, H₂SO₄ or alkaline liquids like KOH, NaOH.

If an absorption layer is used, during the etching process regions of the absorption layer where laser pulses were applied are removed together with regions of the absorption layer where no laser pulses were applied. Such a result is for example obtained, if the absorption layer is a Ni layer and HNO₃ is used as the etchant.

However, it is also possible that during the etching process only the regions of the absorption layer are removed which are located above the regions of the dielectric layer which are removed. To achieve this, for example phase change materials in combination with alkaline and acid liquids can be used.

In accordance with a further development of the method in accordance with the invention, the step of providing a recording stack comprises providing a recording stack further comprising a mirror layer below the dielectric layer. Such a mirror layer improves the overall stack efficiency and makes the bottom surface of the pit smoother.

The mirror layer can, for example, be made from a material selected from the following group: Ag, Al, Si. In any case it is necessary that the mirror layer is resistant to the used etch liquid.

With some embodiments the step of providing a recording stack that comprises providing a recording stack comprising an absorption layer above the dielectric layer and a further absorption layer below the dielectric layer. Such a further lower absorption layer also provides heat from below, making it possible to improve the temperature profile in the upper dielectric layer. Like the upper absorption layer, the further absorption layer has to be made of a material that has a high absorption rate. The biggest difference with the upper absorption layer is the fact that the further absorption layer may not be etchable by the etchant used. Also the needed thickness of this layer depends on many of the material properties, like absorption rate, thermal conductivity, specific heat etc.

In this connection it may be advantageous, if the step of providing a recording stack comprises providing a recording stack further comprising a further dielectric layer below the further absorption layer. The lower dielectric layer provides heat isolation for the lower absorption layer and can consist of any dielectric mentioned. The thickness of the lower dielectric layer, together with its optical properties and the mirror layer provide a way to optimize the stack. Optimizing this thickness can control how the power is divided over the absorption layers. This gives great control over the pit shape.

With some embodiments of the method in accordance with the invention the step of providing a recording stack comprises providing a recording stack further comprising a covering layer. The covering layer is preferably as thin as possible, is present during writing, and is chemically removed via etching. Its function is to prevent the absorption layer to chemical degradation.

The covering layer preferably is made of an etchable dielectric or organic layer, such as photoresist.

With the second embodiment of the method in accordance with the invention, wherein the means for supporting heat induced phase transitions within the dielectric layer comprise a dopant doped into the dielectric layer, the dopant is preferably selected from the following group: N, Sb, Ge, In, Sn. However, also a different ratio ZnS—SiO₂ is possible or a mixture of ZnS—SiO₂ with other absorbing materials.

With the first general embodiment of the method in accordance with the invention, it is also possible that the step of providing a recording stack comprises providing a recording stack comprising a plurality of alternating dielectric layers and absorption layers. Also in this case the further developments discussed above, particularly in connection with the first general embodiment of the method in accordance with the invention, may be applied in the same or a similar manner. As regards the choice of the materials mentioned above, a highly preferred material for the plurality of dielectric layers is ZnS—SiO₂, and a highly preferred material for the plurality of absorption layers is SnGeSb. It is to be noted that also this further development can, for example, also be used for making stampers for the mass fabrication of optical discs, for making optical discs, for making stamps for micro contact printing, and for making microprints. Such methods are discussed below and it is obvious for the person skilled in the art to further develop these methods accordingly. Therefore, also the corresponding feature combinations are disclosed herewith.

In the present context it is preferred that the plurality of alternating dielectric layers and absorption layers is formed by 2 to 20 dielectric layers and 2 to 20 absorption layers, preferably by 5 to 15 dielectric layers and 5 to 15 absorption layers, and most preferably by about 10 dielectric layers and 10 absorption layers.

If a plurality of alternating dielectric layers and absorption layers is provided, the dielectric layers preferably comprise a thickness between 0.5 and 20 nm, preferably between 1 and 10 nm, and most preferably of about 5 nm.

As regards the plurality of absorption layers, these absorption layers preferably comprise a thickness between 0.1 and 10 nm, preferably between 0.2 and 5 nm, and most preferably of about 1 nm.

In accordance with a second aspect of the present invention a master substrate for creating a high-density relief structure is provided, particularly a master substrate for making a stamper for the mass-fabrication of optical discs or a master substrate for creating a stamp for micro contact printing, wherein for forming the high-density relief structure there is provided a dielectric layer doped by a dopant enhancing its absorption properties for laser pulses. Thereby, as already mentioned in connection with the second embodiment of the method in accordance with the invention, the dielectric layer itself is made more absorbing in the wavelength range defined by the dopant. Changing the doping concentration makes the absorption adjustable, and the absorption can, for example, be made high enough to make writing with use of existing lasers possible, but low enough to get a good pit shape.

Also in this case the dopant preferably is selected from the following group: N, Sb, Ge, In, Sn. As already mentioned, also a different ratio ZnS—SiO₂ is possible or a mixture of ZnS—SiO₂ with other absorbing material.

In accordance with a further aspect of the invention, there is provided a master substrate for creating a high-density relief structure, particularly a master substrate for making a stamper for the mass-fabrication of optical discs or a master substrate for creating a stamp for micro contact printing, wherein for forming the high-density relief structure there is provided a dielectric layer containing nanocrystals grown by an annealing process. Thereby, as already mentioned in connection with the third embodiment of the method in accordance with the invention, a blue-shift in the light absorption range of ZnS—SiO₂ can be obtained.

In accordance with a third aspect of the present invention, there is provided a method for providing a high density relief structure in a recording stack of a master substrate, particularly a master substrate for making a stamper for the mass-fabrication of optical discs or a master substrate for creating a stamp for micro contact printing, the method comprising the following steps:
providing a recording stack comprising a dielectric layer;
causing a heat induced phase transition in regions of the dielectric layer where pits/bumps are to be formed by applying laser pulses having a wavelength between 250 and 800 nm, particularly of 405 nm; and
removing the regions of the dielectric layer which have experienced a phase transition by an etching process; or
removing the regions of the dielectric layer which have not experienced a phase transition by an etching process;

This solution is based on the finding that there exist dielectric materials having a rather high absorption coefficient at the specified wavelength range. Therefore, at least in some cases, no additional absorption layer and no additional doping material is required to enable direct recording.

A preferred dielectric layer for writing with the specified wavelength range is a ZnS—SiO₂ layer. ZnS—SiO₂ at 257 nm wavelength comprises an absorption coefficient of about k=0.5. Another possibility to record ZnS—SiO₂, particularly untreated ZnS—SiO₂, is, for example, to use a wavelength of 266 nm, particularly in connection with the use of a LBR. Preferred write powers range between 0.5 and 1.5 mW.

When using ZnS—SiO₂ for PTM mastering, the regions where no laser pulses were applied and which have not experienced a phase transition (the unrecorded areas) are removed by an etching process. Thus, the recorded material remains as a bump structure forming an inverse polarity structure compared to the case when the recorded material is removed. As a consequence of this inverse polarity there exists the risk of underetching the bump structure leading to problems, e.g. during separating the master substrate and a stamper grown thereon. In order to solve this problem of underetching, the ZnS component of the ZnS—SiO₂ layer (14) preferably is present with less than 80% weight percentage. Thereby, the absorption of the PTM material can be lowered. While the default ratio is ZnS—SiO₂=80%-20% weight percentage, it is preferred in this connection that the ratios are ZnS—SiO₂=70%-30% and ZnS—SiO₂=60%-40%, for example. With this solution the problem of underetching can be overcome or at least reduced.

A further possibility to avoid or at least reduce underetching as mentioned above is that the recording stack comprises at least one absorption layer. One or more absorption layers can be added to the recording stack to induce an extra heat flow from below. In this case, heat is generated in the absorption layer as well, in that way improving the bump shape. Possible absorption layers are for example SbTe, Si, Ag, Al, etc. When the ZnS—SiO2 layer is fully developed (etched up to the absorption layer), the absorption layer should be etch-resistant. After exposure, for example to HNO₃, bumps with a taper-like profile remain.

It is also possible that after the etching process a coating is applied. For example, the developed master substrate can be covered with a silane film (or another spin-coated organic film) to fill the underetched regions. The capillary forces will make the polymer layer remain in the underetched parts of the bumps and improve in that way the bump.

Particularly to avoid or reduce underetching, embodiments are envisaged, wherein the etching process is stopped before an underetching of regions of the dielectric layer that shall not be removed occurs. If the etching process is well controlled, a predetermined depth can be obtained and underetching is prevented.

In accordance with a further embodiment the dielectric layer comprises a first surface arranged close to the laser during the application of the laser pulses and a second surface arranged afar from the laser during the application of the laser pulses, and wherein the etching process starts on the second surface of the dielectric layer. This technique can be referred to as “bump shape reversal” and it is one of the possibilities to obtain a proper bump shape. For example, before wet etching, a stamper is grown from the exposured PTM master. Then, the master substrate and the stamper are separated at the ZnS—SiO2-glass interface. Subsequently, the recorded PTM layer is developed. The resulting bump structure has the proper bump shape, directly suitable for replication or mother stamper growing.

In accordance with a fourth aspect of the present invention, there is provided a method for making a stamper for the mass-fabrication of optical discs, the method comprising the following steps:
providing a recording stack comprising a dielectric layer and means for supporting heat induced phase transitions within the dielectric layer;
causing a heat induced phase transition in regions of the dielectric layer where pits/bumps are to be formed by applying laser pulses;
removing the regions of the dielectric layer, which have experienced a phase transition, by an etching process; or
removing the regions of the dielectric layer, which have not experienced a phase transition, by an etching process; and
making the stamper on the basis of the recording stack.

In accordance with a fifth aspect of the present invention, there is provided a method for making an optical disc, the method comprising the following steps:
providing a recording stack comprising a dielectric layer and means for supporting heat induced phase transitions within the dielectric layer;
causing a heat induced phase transition in regions of the dielectric layer where pits/bumps are to be formed by applying laser pulses;
removing the regions of the dielectric layer, which have experienced a phase transition, by an etching process; or
removing the regions of the dielectric layer, which have not experienced a phase transition, by an etching process;
making a stamper on the basis of the recording stack; and
using the stamper to make the optical disc.

In accordance with a sixth aspect of the present invention, there is provided a method for making a stamp for micro contact printing, the method comprising the following steps:
providing a recording stack comprising a dielectric layer and means for supporting heat induced phase transitions within the dielectric layer;
causing a heat induced phase transition in regions of the dielectric layer where pits/bumps are to be formed by applying laser pulses;
removing the regions of the dielectric layer, which have experienced a phase transition, by an etching process; or
removing the regions (26) of the dielectric layer (14), which have not experienced a phase transition, by an etching process; and
   making the stamp (42) on the basis of the recording stack.

In accordance with a seventh aspect of the present invention, there is provided a method for making a microprint, the method comprising the following steps:
providing a recording stack comprising a dielectric layer and means for supporting heat induced phase transitions within the dielectric layer;
causing a heat induced phase transition in regions of the dielectric layer where pits/bumps are to be formed by applying laser pulses;
removing the regions of the dielectric layer, which have experienced a phase transition, by an etching process; or
removing the regions of the dielectric layer, which have not experienced a phase transition, by an etching process;
   making a stamp on the basis of the recording stack; and
   using the stamp to make the microprint.

In accordance with a eighth aspect of the present invention, there is provided a method for making a stamper for the mass-fabrication of optical discs, the method comprising the following steps:
providing a recording stack comprising a dielectric layer;
causing a heat induced phase transition in regions of the dielectric layer where pits/bumps are to be formed by applying laser pulses having a wavelength between 250 and 264 nm, particularly of 257 nm;
removing the regions of the dielectric layer which have experienced a phase transition by an etching process; or
removing the regions of the dielectric layer which have not experienced a phase transition by an etching process; and
making the stamper on the basis of the recording stack.

In accordance with a ninth aspect of the present invention, there is provided a method for making an optical disc, the method comprising the following steps:
providing a recording stack comprising a dielectric layer;
causing a heat induced phase transition in regions of the dielectric layer where pits/bumps are to be formed by applying laser pulses having a wavelength between 250 and 264 nm, particularly of 257 nm;
removing the regions of the dielectric layer which have experienced a phase transition by an etching process; or
removing the regions of the dielectric layer which have not experienced a phase transition by an etching process;
making a stamper on the basis of the recording stack; and
using the stamper to make the optical disc.

In accordance with a tenth aspect of the present invention, there is provided a method for making a stamp for micro contact printing, the method comprising the following steps:
providing a recording stack comprising a dielectric layer;
causing a heat induced phase transition in regions of the dielectric layer where pits/bumps are to be formed by applying laser pulses having a wavelength between 250 and 264 nm, particularly of 257 nm;
removing the regions of the dielectric layer which have experienced a phase transition by an etching process; or
removing the regions of the dielectric layer which have not experienced a phase transition by an etching process; and
making the stamper on the basis of the recording stack.

In accordance with an eleventh aspect of the present invention, there is provided a method for making a microprint, the method comprising the following steps:
providing a recording stack comprising a dielectric layer;
causing a heat induced phase transition in regions of the dielectric layer where pits/bumps are to be formed by applying laser pulses having a wavelength between 250 and 264 nm, particularly of 257 nm;
removing the regions of the dielectric layer which have experienced a phase transition by an etching process; or
removing the regions of the dielectric layer which have not experienced a phase transition by an etching process;
making a stamp on the basis of the recording stack (10); and
using the stamp to make the microprint.

These and other aspects of the invention will be apparent from and elucidated with reference to the embodiments described hereinafter.

Furthermore, it is clear that the solutions in accordance with the fourth to eleventh aspects of the invention may be further developed corresponding to the embodiments and details disclosed in connection with the first to third aspects of the invention, and all combinations of the respective features shall be deemed to be disclosed hereby, even if presently not explicitly claimed with the appending claims.

### BRIEF DESCRIPTION OF THE DRAWINGS

FIGS. 1a to 1c schematically show a first embodiment of a master substrate in accordance with the present invention during processing by a method in accordance with the invention;

FIG. 1ci schematically shows the making of a stamper and a stamp, respectively;

FIG. 1cii schematically shows the making of an optical disc;

FIG. 1ciii schematically shows the making of a microprint;

FIGS. 1d and 1e show sectional analyses of the results of practical experiments made on the basis of a master substrate in accordance with FIGS. 1a to 1c;

FIGS. 1f and 1g show surface analyses of the results of practical experiments made on the basis of a master substrate in accordance with FIGS. 1a to 1c;

FIGS. 2a to 2c schematically show a second embodiment of a master substrate in accordance with the present invention during processing by a method in accordance with the invention;

FIGS. 3a to 3c schematically show a third embodiment of a master substrate in accordance with the present invention during processing by a method in accordance with the invention;

FIGS. 4a to 4c schematically show a fourth embodiment of a master substrate in accordance with the present invention during processing by a method in accordance with the invention;

FIGS. 5a to 5c schematically show a fifth embodiment of a master substrate in accordance with the present invention during processing by a method in accordance with the invention;

FIGS. 5d and 5e show surface analyses of the results of practical experiments made on the basis of a master substrate with a lower absorption layer;

FIGS. 6a to 6c schematically show a sixth embodiment of a master substrate in accordance with the present invention during processing by a method in accordance with the invention;

FIGS. 7a to 7c schematically show a seventh embodiment of a master substrate in accordance with the present invention during processing by a method in accordance with the invention;

FIGS. 7d and 7e show sectional analyses of the results of practical experiments made on the basis of a master substrate in accordance with FIGS. 7a to 7c;

FIG. 7f shows Differential Scanning Calorimeter measurements giving information about the phase transition of ZnS—SiO₂;

FIG. 7g shows a comparison between calculated (simulated) and measured (via Atomic Force Microscopy) full width half maximum widths of marks recorded and etched in ZnS—SiO₂;

FIGS. 8a to 8c schematically show an eighth embodiment of a master substrate in accordance with the present invention during processing by a method in accordance with the invention;

FIG. 8d illustrates a targeted BD-ROM pit size, the intensity profile of a focused spot in a blue system (NA=0.85, 405 nm) and the intensity profile in a liquid immersion deep UV system (NA=1.2, 257 nm);

FIG. 8e shows a surface analysis of the result of a practical experiment made on the basis of a master substrate in accordance with FIGS. 8a to 8c;

FIG. 8f shows a sectional analysis of the result of the practical experiment in accordance with FIG. 8e;

FIG. 8g shows a surface analysis of the result of a further practical experiment made on the basis of a master substrate in accordance with FIGS. 8a to 8c;

FIG. 8h shows a sectional analysis of the result of the practical experiment in accordance with FIG. 8g;

FIG. 9a is a graph illustrating the growth of ZnS nanocrystals depending on the temperature;

FIG. 9b is a graph illustrating transmission spectra of nano-composite samples with a high ZnS content;

FIGS. 9c to 9f schematically show a further embodiment of a master substrate in accordance with the present invention during processing by a method in accordance with the invention; and

FIGS. 10a to 10h schematically show a marking mechanism in a dielectric layer of a master substrate, including a comparison of a conventional resist master (FIGS. 10c to 10e) and a ZnS—SiO₂ PTM master (FIGS. 10f to 10h);

FIGS. 11a and 11b show a further embodiment of a master substrate in accordance with the present invention during processing by a method in accordance with the invention;

FIGS. 12a to 12e show a further embodiment of a master substrate in accordance with the present invention during processing by a method in accordance with the invention and the respective measurement results;

FIGS. 13a to 13d show a further embodiment of a method in accordance with the invention and the respective processing stages; and

FIGS. 14a to 14e show a further embodiment of a master substrate 12 in accordance with the present invention during processing by a method in accordance with the invention.

### DESCRIPTION OF PREFERRED EMBODIMENTS

Throughout the drawings equal or similar reference numerals are assigned to equal or similar components which are explained only once in most cases to avoid repetitions.

### Embodiment 1

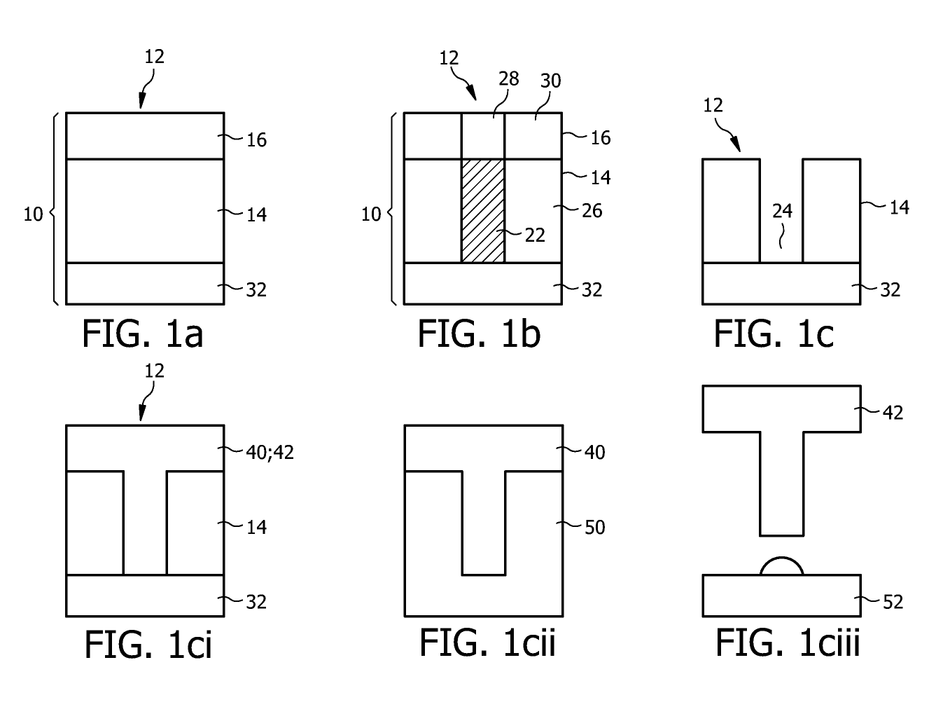

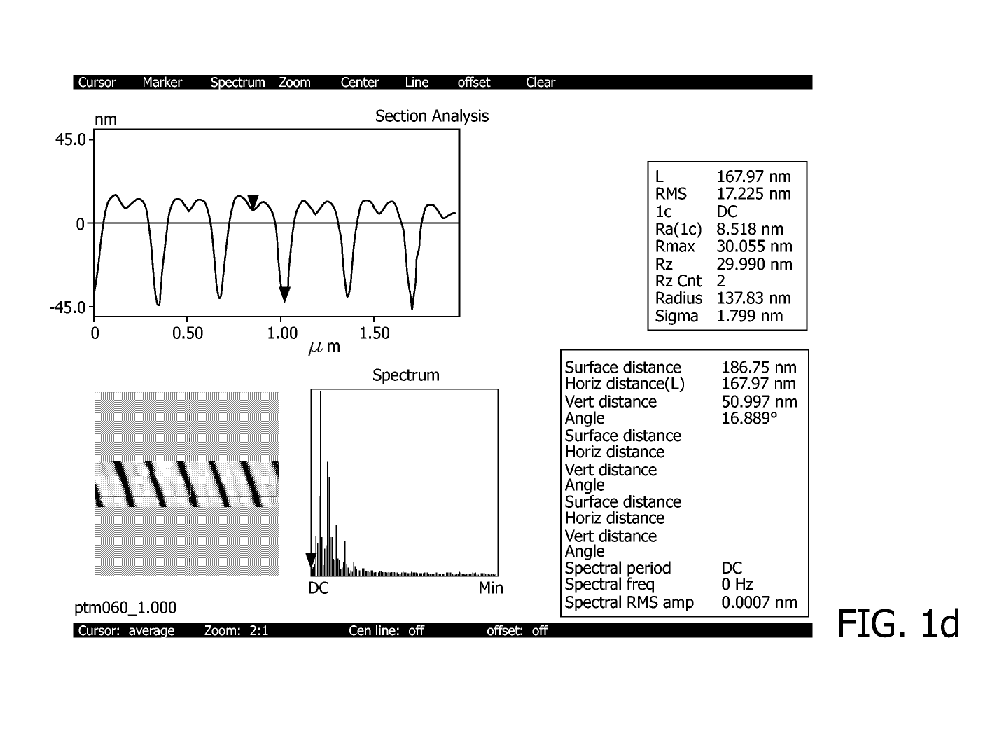

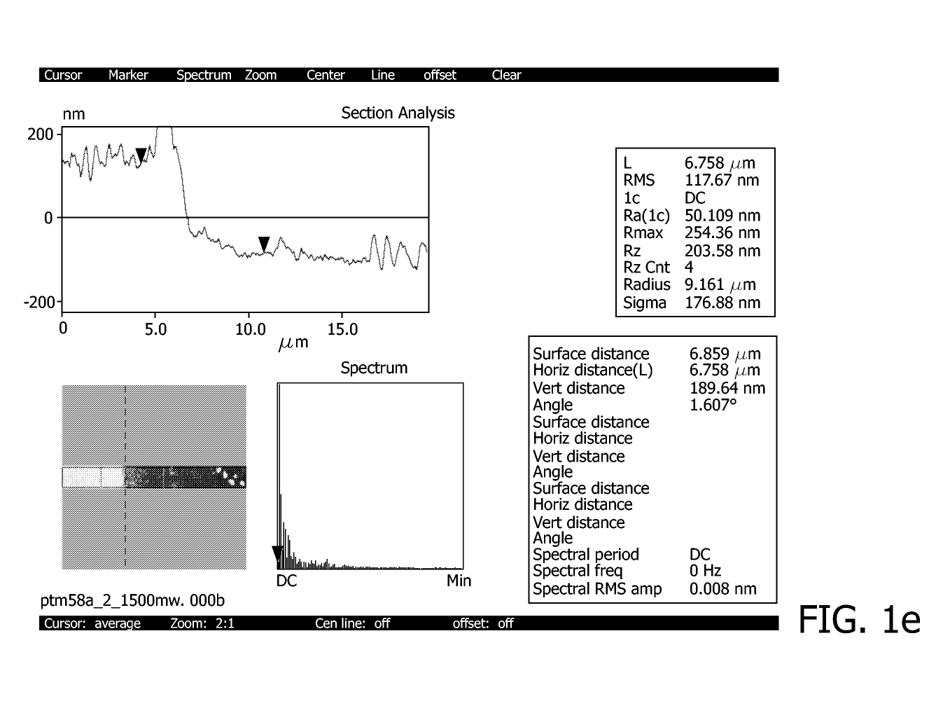

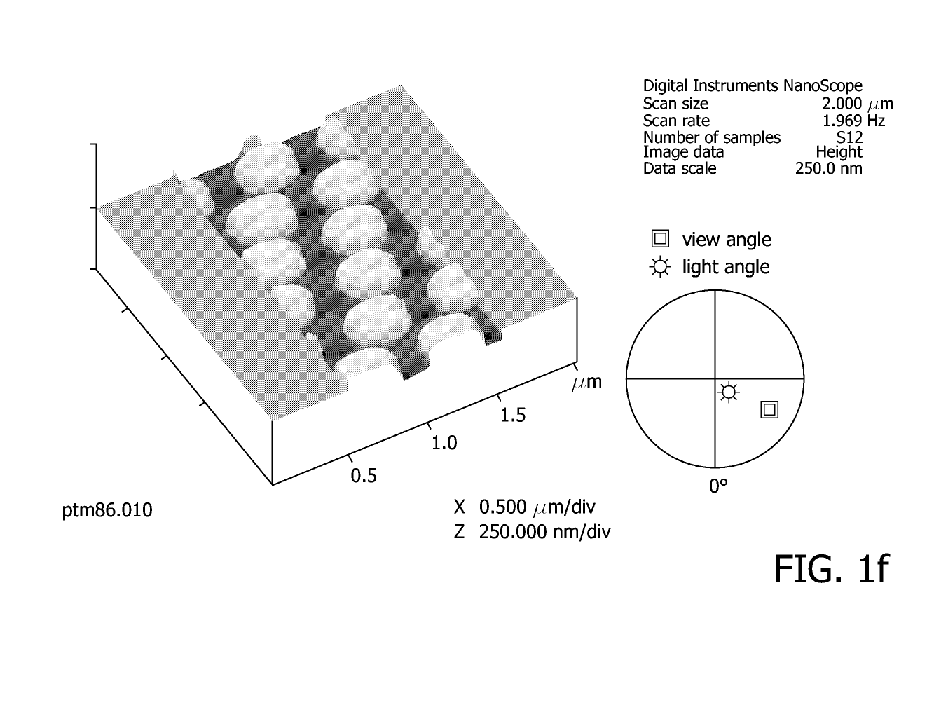

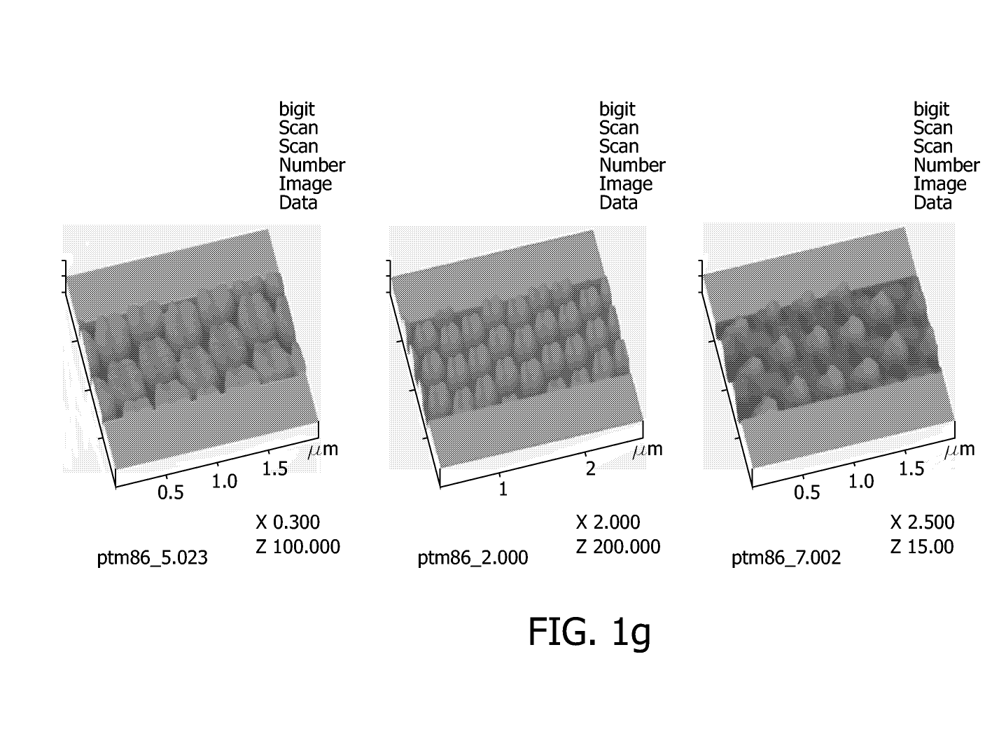

FIGS. 1a to 1c show a first embodiment of a master substrate 12 in accordance with the present invention during processing by a method in accordance with the invention, wherein FIG. 1a shows the master substrate 12 untreated, FIG. 1b shows the master substrate 12 after writing, and FIG. 1c shows the master substrate 12 after etching.

The recording stack 10 of the master substrate 12 comprises a dielectric layer 14 carrying an absorption layer 16. Under the dielectric layer 14 there is provided an optional mirror layer. The absorption layer 16 in this embodiment can be practically any material that has a high absorption rate and is unselectively etchable. Many metals (e.g. Ni, Cu, Ag, etc.) can be used as absorber. Crystalline phase change materials (e.g. GeSbTe, doped Sb₂Te) that have a rather high melting temperature can also be used as absorber. A preferred material is Ni because of its availability and inertness to oxidation. The needed thickness of the absorption layer 16 depends on many of the material properties, like absorption rate, thermal conductivity, specific heat etc. For nickel, for example, 10 nm worked.

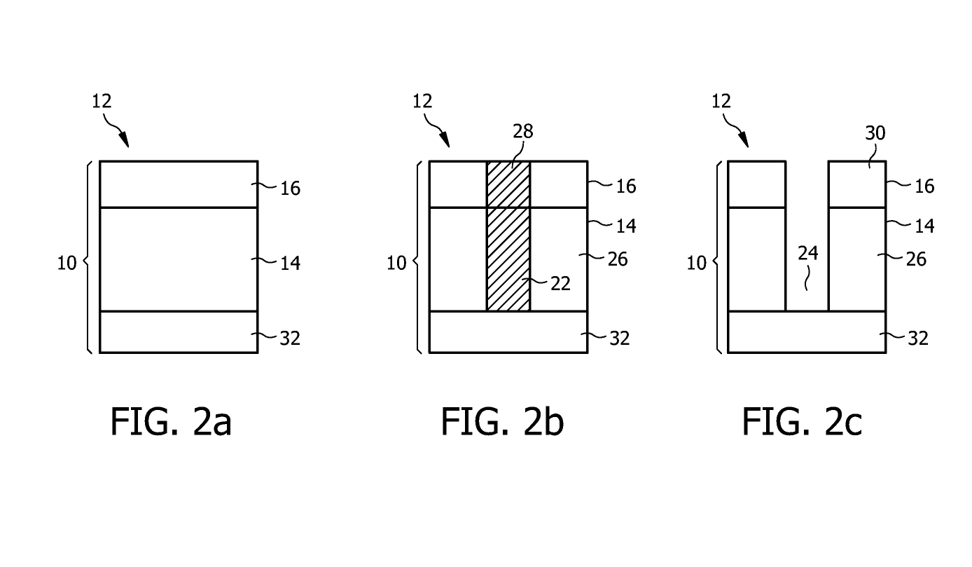

With the embodiment of FIGS. 1a to 1c the dielectric layer 14 is ZnS—SiO₂, but other dielectrics might also show selective etching. The thickness of this dielectric layer 14 will determine the possible depth of the pits 24 to be formed. The mirror layer 32 is optional and can be made out of metals like Ag, Al, Si, etc. As long as the layer below the dielectric layer 14 is unetchable by the used etchant, it can be used. This can be the substrate itself, but an added mirror layer 32 improves the overall stack efficiency and makes the bottom surface of the pit 24 smoother. If necessary, a covering layer can be used to prevent oxidation or material shifts due to melting. This covering layer is not shown in FIGS. 1a to 1c (and also not in FIGS. 2 to 6), but it can be provided with all embodiments described herein. The covering layer can be made of an etchable dielectric or organic layer and should be as thin as possible. As an etchant, acid solutions like HNO₃, HCl, H₂SO₄ or alkaline liquids like KOH and NaOH can be used. The resulting relief structure after etching is given in FIG. 1d-e.

With the master substrate 12 of FIG. 1a the method of the invention can be carried out as follows:

First, the recording stack 10 shown in FIG. 1a and comprising a dielectric layer 14 and means 16 for supporting heat induced phase transitions within the dielectric layer 14 is provided, wherein the means for supporting heat induced phase transitions within the dielectric layer 14 are realized by the absorption layer 16.

Then, a heat induced phase transition is caused in the region 22 of the dielectric layer 14 where the pit 24 is to be formed by applying laser pulses. The result is shown in FIG. 1b.

Finally, the region 22 of the dielectric layer 14, which has experienced a phase transition, is removed by an etching process. As may be seen from FIG. 1c, the complete absorption layer 16 as well as the written dielectric layer 22 is dissolved in the etch liquid.

FIG. 1ci schematically shows the making of a stamper 40 and a stamp 42, respectively. The stamper 40 and the stamp 42, respectively, is formed on the basis of the high-density relief structure 24. To provide the metal layer, for example, a thin Ni layer is sputter-deposited on the high-density relief structure 24 formed in the recording stack of the master substrate 12. This Ni layer is subsequently electro-chemically grown to a thick manageable stamper 40 or stamp 42. The stamper 40 or the stamp 42 is separated from the master substrate 26 and further processed (cleaned, punched etc.).

FIG. 1cii schematically shows the making of an optical disc 50 on the basis of the stamper 40, as it is well known to the person skilled in the art.

FIG. 1ciii schematically shows the making of a microprint 52 on the basis of the stamp 42, as it is also well known by the person skilled in the art.

FIG. 1d shows a sectional analysis of the result of the following practical experiment. A pre-grooved BD-RE substrate with track pitch 320 nm was provided with a recording stack, comprising an 87 nm thick ZnS—SiO₂ layer and a 10 nm Ni absorption layer. The pre-grooves were used for tracking. Continuous grooves were written in the pre-grooved stack by application of a continuous laser power (Pultsec, NA=0.85, 405 nm wavelength, continuous power of 3.4 mW). The Ni layer and written sections in the ZnS—SiO₂ layer were etched with 1% HNO₃ for 15 minutes. The peculiar shape indicates that the heated ZnS—SiO₂ layer is partially etched. The measured depth profile indicates the presence of deep and shallow grooves. The shallow grooves are the left over of the pre-groove after sputter-deposition of the recording stack. The deep grooves are caused by selective etching of the written ZnS—SiO₂ layer. After etching is performed, the final pit will be completely written in one material. This will rule out the possibility of underetching and will give smooth pit walls.

FIG. 1e shows a sectional analysis of the result of another practical experiment. A polycarbonate substrate was provided with a 200 nm thick ZnS—SiO₂ layer and an absorption layer of Cu. A trace of 100 μm width was written with a Hitachi initializer (810 nm wavelength, 100 μm broad spot). After dissolution of the disc in HNO₃, a step height of 190 nm resulted. This example shows that the process also works using a different absorption layer and different laser wavelength. The sample is less smooth. This is because the use of copper, which is highly susceptible to oxidation.

FIG. 1f shows an example of a bump structure written with the Pulstec. Again a 100 nm ZnS—SiO₂ layer with 10 nm Ni top layer was used. A single tone of 14T length was written in the disc. The illuminated discs were treated with 1% HNO₃ for 15 minutes. We clearly see an imprint of the pre-groove, the shallow groove that is present in both the bumps and the intermediate lands. The bumps/pits are rather wide because of the indirect heating effect. The wall angle is quite large. Also the obtained pit depth is almost the initial ZnS—SiO₂ layer thickness steep.

FIG. 1g shows an example that the time can be varied to control the size of the written bumps. Three-dimensional AFM scans of a bump structure for three different dissolution times are shown, namely 5 (left image), 15 (middle image) and 25 minutes (right image) in 1% HNO₃. This illustrates that also the crystalline state is dissolved in HNO₃ but much slower than the unwritten amorphous phase. Apparently a dissolution time of 25 minutes is too long, 15 minutes seems to be optimum for these write conditions in combination with stack design.

### Embodiment 2

FIGS. 2a to 2c show a second embodiment of a master substrate 12 in accordance with the present invention during processing by a method in accordance with the invention, wherein FIG. 2a shows the master substrate 12 untreated, FIG. 2b shows the master substrate 12 after writing, and FIG. 2c shows the master substrate 12 after etching.

Also with this embodiment the recording stack 10 of the master substrate 12 comprises a dielectric layer 14 carrying an absorption layer 16, and under the dielectric layer 14 there is provided an optional mirror layer 32. However, with this embodiment the absorption layer 16 is a layer of which only the written phase is etchable by the etchant used to etch the dielectric layer 14. This adds some extra depth to the eventual pit 24, see FIG. 2c. Like in embodiment 1, many materials can be used for the absorption layer 16, like many metals or compositions like nucleation dominated phase change materials. For example phase change materials in combination with alkaline and acid liquids can be used.

With the master substrate 12 of FIG. 2a the method of the invention can be carried out as follows:

First, the recording stack 10 shown in FIG. 2a and comprising a dielectric layer 14 and means 16 for supporting heat induced phase transitions within the dielectric layer 14 is provided, wherein the means for supporting heat induced phase transitions within the dielectric layer 14 are realized by the selectively etchable absorption layer 16.

Then, a heat induced phase transition is caused in the region 22 of the dielectric layer 14 where the pit 24 is to be formed by applying laser pulses. The result is shown in FIG. 2b.

Finally, the region 22 of the dielectric layer 14, which has experienced a phase transition, is removed by an etching process. As may be seen by comparing FIGS. 2b and 2c, in this case only the region 28 of the absorption layer 16 above the region 22 of the dielectric layer 14 is dissolved in the etch liquid.

In accordance with embodiment 2 it is for example also possible that the absorption layer 16 is replaced by a growth-dominated phase-change material (e.g. InGeSbTe, SnGeSb, etc.). The written mark 28 of the absorption layer 16 is etchable by the same etchant used to selectively etch region 22 of the dielectric layer 14. This potentially decreases the channel bit length through growth back. Also in this case the method in accordance with the invention can be carried out as described above.

### Embodiment 3

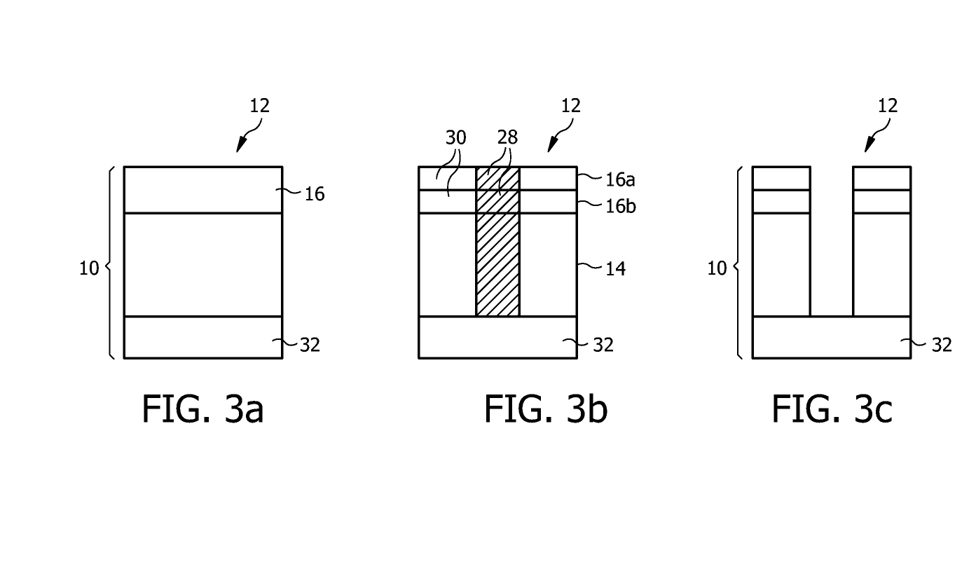

FIGS. 3a to 3c show a third embodiment of a master substrate 12 in accordance with the present invention during processing by a method in accordance with the invention, wherein FIG. 3a shows the master substrate 12 untreated, FIG. 3b shows the master substrate 12 after writing, and FIG. 3c shows the master substrate 12 after etching.

The recording stack 10 of the master substrate 12 also in this case comprises a dielectric layer 14 carrying an absorption layer 16, and under the dielectric layer 14 there is provided an optional mirror layer 32. However, with the third embodiment the absorption layer 16 is formed by a silicide forming layer like Cu—Si or Ni—Si. In embodiment 3 only the region 28, i.e. the written phase of the absorption layer 16 is dissolved, i.e. in the unwritten regions 30 both, the upper silicide forming layer 16a and the lower part 16b of the absorption layer 16 are not dissolved. An advantage of this is added pit depth.

With the master substrate of FIG. 3a the method in accordance with the present invention can be carried out as described above in connection with embodiment 2.

### Embodiment 4

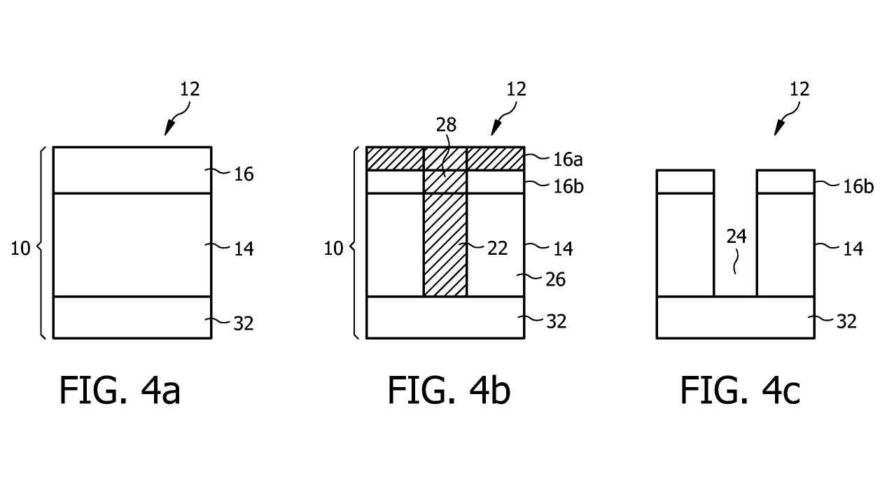

FIGS. 4a to 4c show a fourth embodiment of a master substrate 12 in accordance with the present invention during processing by a method in accordance with the invention, wherein FIG. 4a shows the master substrate 12 untreated, FIG. 4b shows the master substrate 12 after writing, and FIG. 4c shows the master substrate 12 after etching.

With embodiment 4 the recording stack 10 of the master substrate 12 is the same as described in connection with embodiment 3. However, in accordance with embodiment 4 both, the written phases 28, 22 and the topmost unwritten layer 16a are dissolved when the method described above in connection with embodiment 1 is applied. The result is shown in FIG. 4c. An advantage of this is added pit depth and an improved top surface smoothness.

### Embodiment 5

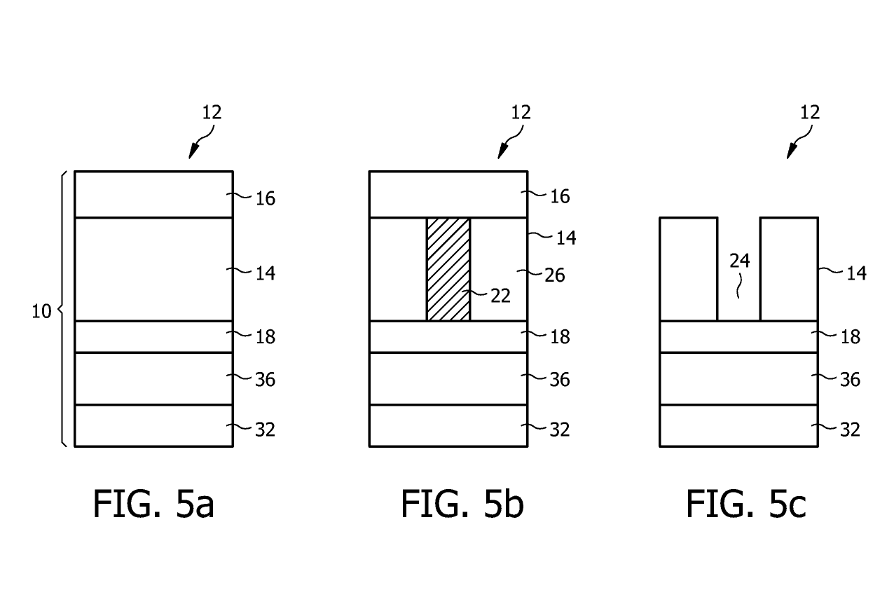

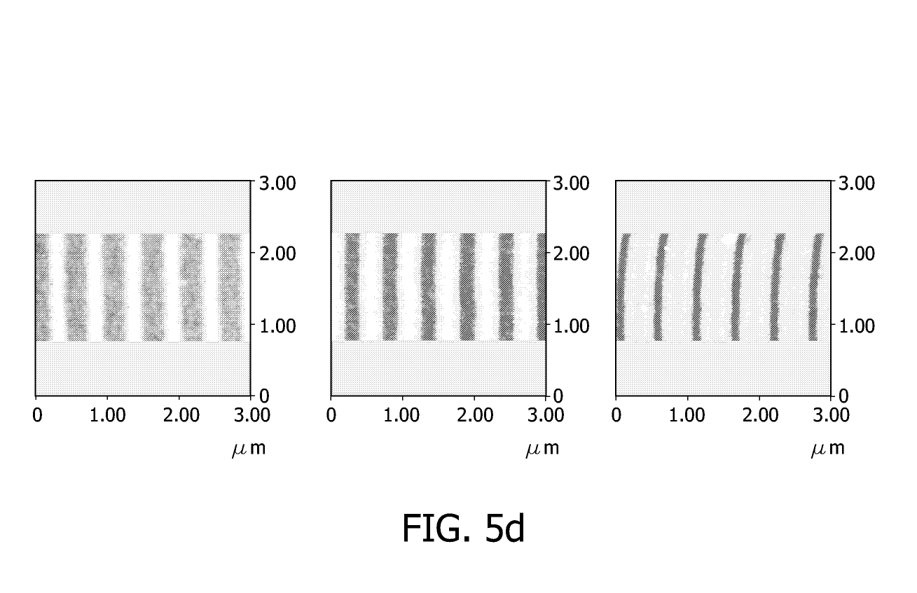

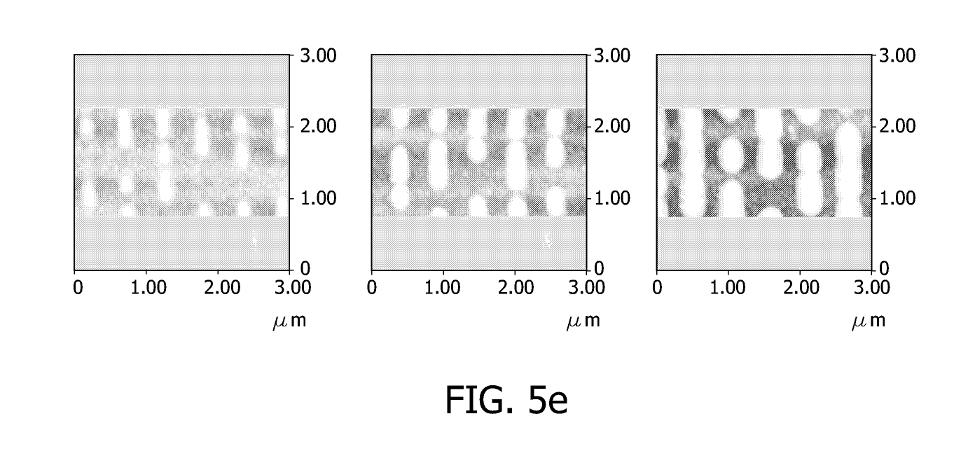

FIGS. 5a to 5c show a fifth embodiment of a master substrate 12 in accordance with the present invention during processing by a method in accordance with the invention, wherein FIG. 5a shows the master substrate 12 untreated, FIG. 5b shows the master substrate 12 after writing, and FIG. 5c shows the master substrate 12 after etching.

In accordance with embodiment 5 the upper absorption layer 16 and the dielectric layer 14 are as proposed in any of embodiments 1 to 4. However, there is added a further absorption layer 18 for providing heat also from below, making it possible to improve the temperature profile in the upper dielectric layer 14. Like the upper absorption layer 16, this layer 18 has to be made of a material that has a high absorption rate. The biggest difference with the upper absorption layer 16 is the fact that the further absorption layer 18 may not be etchable by the etchant used. The needed thickness of this layer 18 depends on many of the material properties, like absorption rate, thermal conductivity, specific heat etc. Furthermore, there is provided a further dielectric layer 36, which is arranged below the further absorption layer 18. The lower dielectric layer 36 provides heat isolation for the lower absorption layer 18 and can consist of any dielectric mentioned. The thickness of the lower dielectric layer 36, together with its optical properties and the mirror layer 32 provide a way to optimize the stack. Optimizing this thickness can control how the power is divided over the absorption layers. This gives great control over the pit shape.

With embodiment 5 the method in accordance with the invention can be applied as described above in connection with embodiment 1. The result is shown in FIG. 5c.

It is also possible to consider only the lower absorption layer 18 and omit the upper absorption layer 16. In this connection the following experiments were performed with a recording stack, comprising a 25 nm ZnS—SiO₂ recording layer, a 25 nm phase-change absorption layer (InGeSbTe), a 10 nm ZnS—SiO₂ interface layer and a 100 nm Ag layer (maybe provide a drawing of the stack). Laser-induced heating of the phase-change layer caused indirect heating of the ZnS—SiO₂ top layer via diffusion. The phase-change layer was made crystalline prior to mastering. Continuous amorphous traces were written by applying a continuous laser power, amorphous marks were written by applying a pulsed write strategy. The write strategy contained short write pulses to allow for a sufficient cooling time in between the write pulses in order to melt-quench the phase-change film. The first write experiments were performed with an N-strategy. In such a write strategy, a 3T mark is written with three write pulses. The recorded disc was treated with NaOH developer (10%).

FIG. 5d shows AFM plots of grooves written with three different power settings (413 LBR, 25 nm ZnS—SiO₂ film, 10 minutes with 10% NaOH), wherein the groove depth was 20 nm. The illuminated area remains as land plateaus after etching with NaOH. A higher write power leads to a wider land plateau (lands are light stripes) and a narrower groove in between the lands (grooves are the dark stripes).

FIG. 5e shows examples of written data. The unwritten ZnS—SiO₂ phase dissolved in the alkaline liquid while the written areas remained at the surface. These recorded areas remain as bumps at the surface. The three panels represent three different recording powers. A pulsed write strategy was used to write these marks. FIG. 5e shows AFM images of data patterns written with the 413 nm LBR in a recording stack with a 25 nm thick ZnS—SiO₂ cover layer and an InGeSbTe phase-change film, for three write powers, 33 ILV (left image), 39 ILV (middle image) and 51 ILV (right image) (10 minutes @ 10% NaOH, TP=500 nm).

### Embodiment 6

While the above embodiments 1 to 5 are related to the first general embodiment, embodiment 6 is related to the second general embodiment, wherein a dopant is used to enhance the absorption properties.

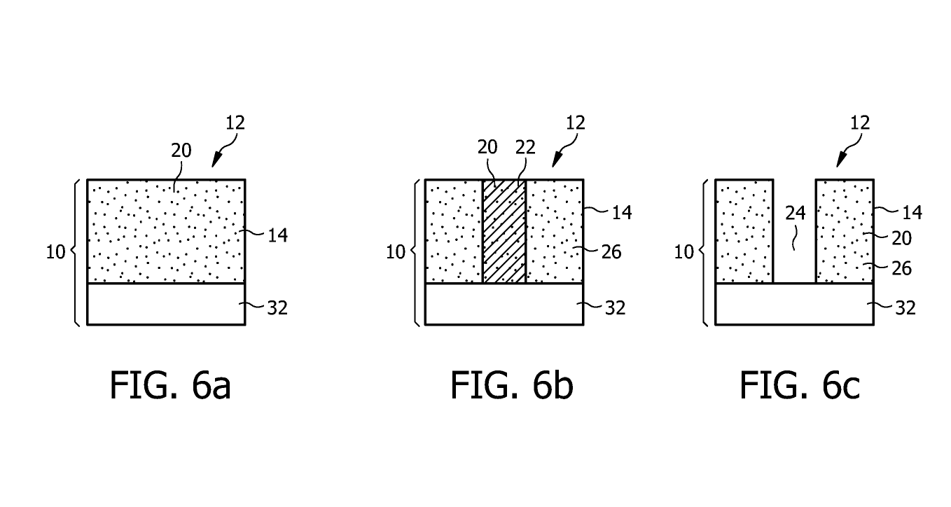

FIGS. 6a to 6c show a sixth embodiment of a master substrate 12 in accordance with the present invention during processing by a method in accordance with the invention, wherein FIG. 6a shows the master substrate 12 untreated, FIG. 6b shows the master substrate 12 after writing, and FIG. 6c shows the master substrate 12 after etching.

With embodiment 6 the recording stack 10 of the master substrate 12 comprises a dielectric layer 14 which is doped by a suitable dopant 20 for enhancing the absorption properties. Under the dielectric layer 14 there is provided an optional mirror layer 32. The dopant is preferably selected from the following group: N, Sb, Ge, In, Sn. However, also a different ratio ZnS—SiO₂ is possible or a mixture of ZnS—SiO₂ with other absorbing material.

The dopant ensures that, even if no absorption layer is present, by applying laser pulses a heat induced phase transition is ensured in region 22 of the dielectric layer 14 (see FIG. 6c) where the pit 24 is to be formed. The result of the etching process is shown in FIG. 6c.

For example, doping ZnS—SiO₂ with blue-absorbent phase change materials can be achieved with the following methods: A target with ZnS—SiO₂ and GeSbSn mixed together can be prepared. The proportion of the absorbent material in the composition has to be sufficient for absorbing light at a 405 nm wavelength, but should also remain low enough to avoid any noise on the phase transition of ZnS—SiO₂. A suitable composition was found to be around 15% (vol.) of GeSbSn and 80% (vol.) of ZnS—SiO₂. As it is known as such in the art, the doping can also be performed using two separated targets of ZnS₈₀—SiO₂_{_{—}}₂₀ (at. %) and Ge_{12.6}Sb_{69.2}Sn_{18.3} (at. %). To co-deposit ZnS—SiO₂ and GeSbSn, a disk of ZnS—SiO₂ with outer diameter the same as the target can be put in close contact to the GeSbSn target. To allow the sputtering of GeSbSn, a circular hole can be created in the center of the ZnS—SiO₂ disk. The diameter of the hole determines the ratio of the sputtered GeSbSn/ZnS—SiO₂.

### Embodiment 7

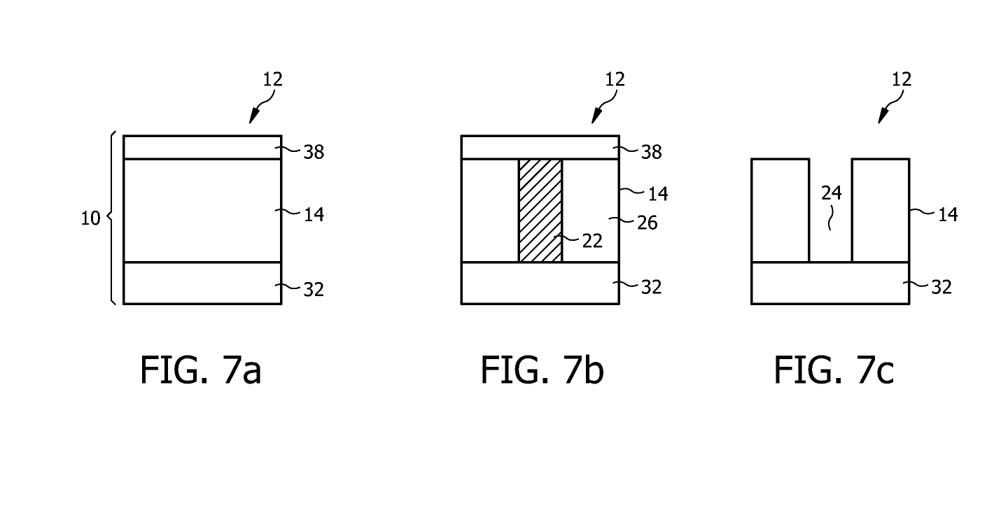

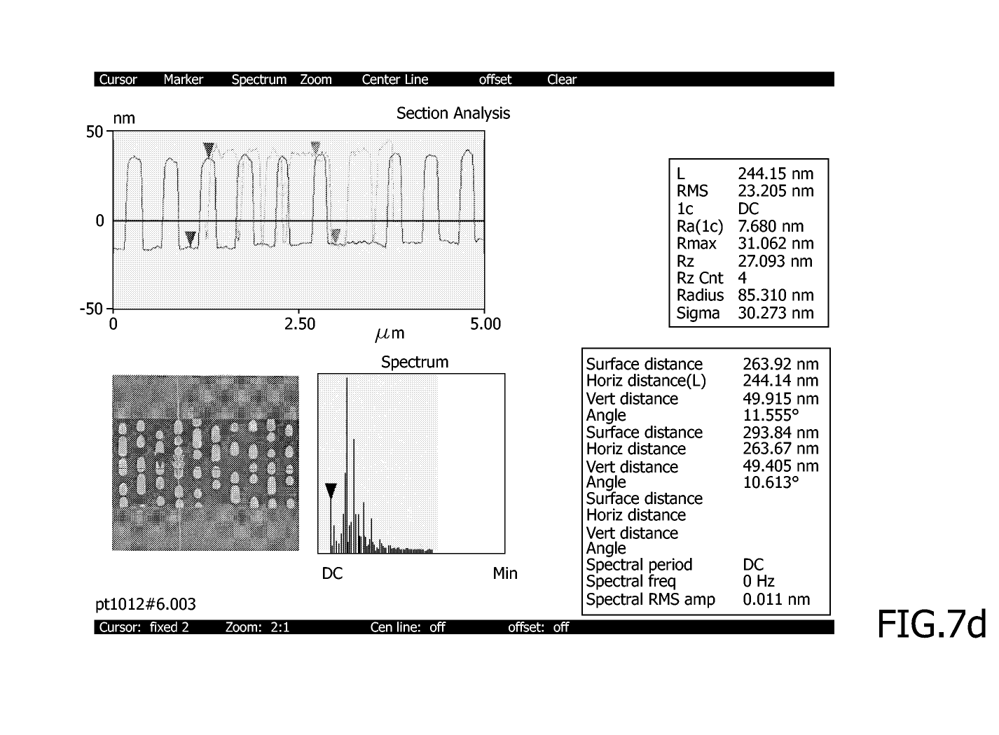

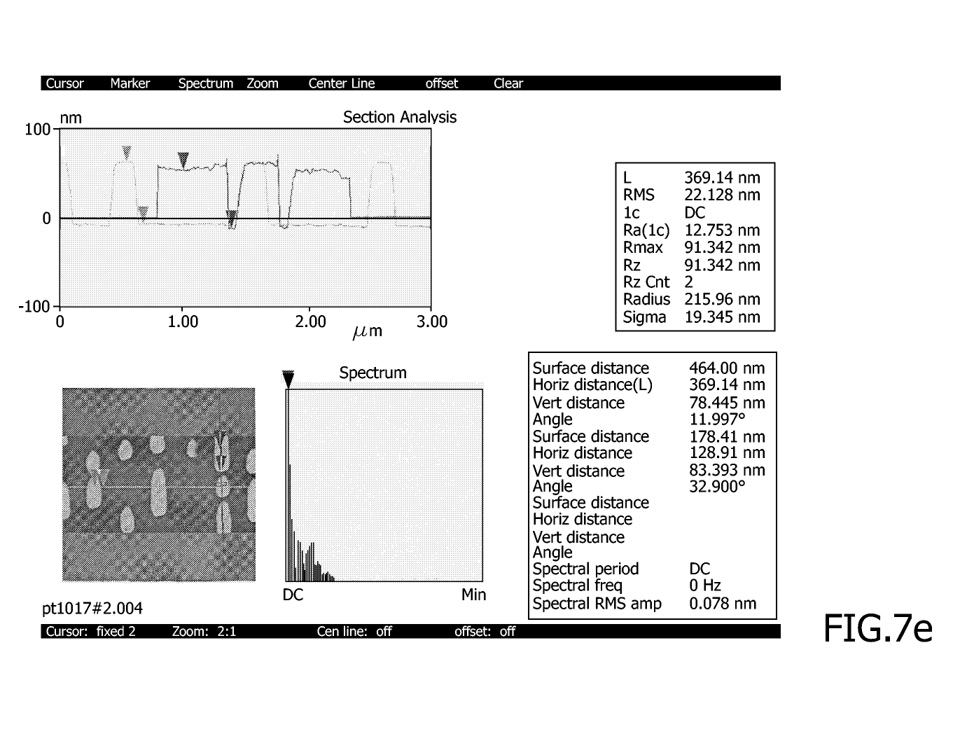

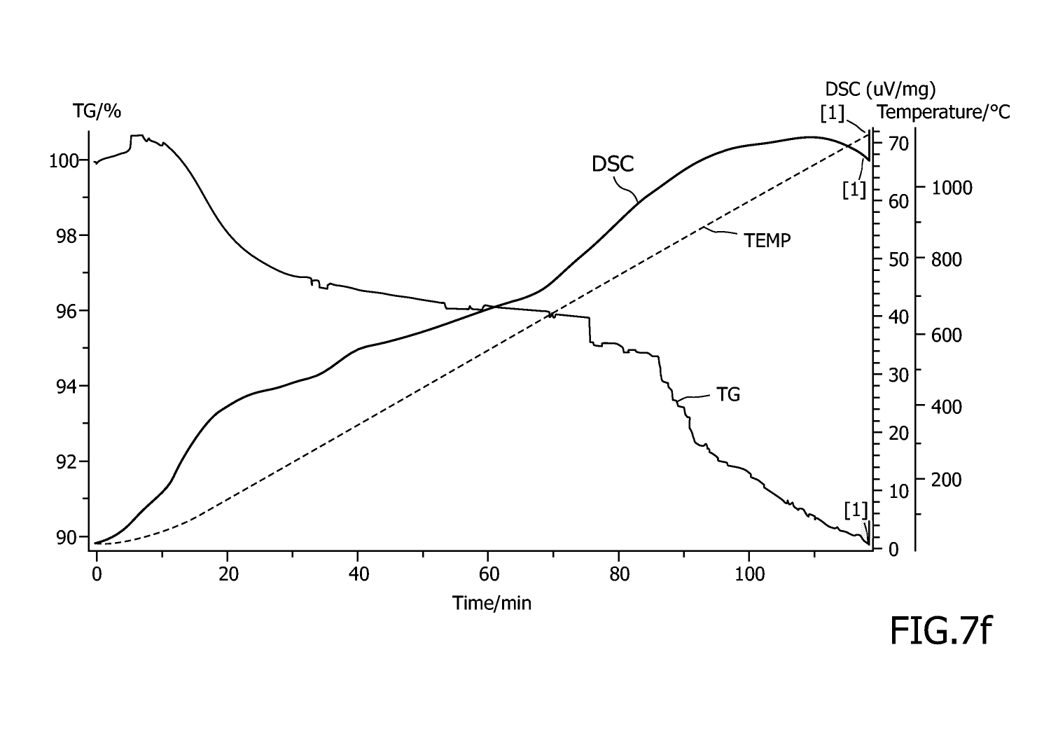

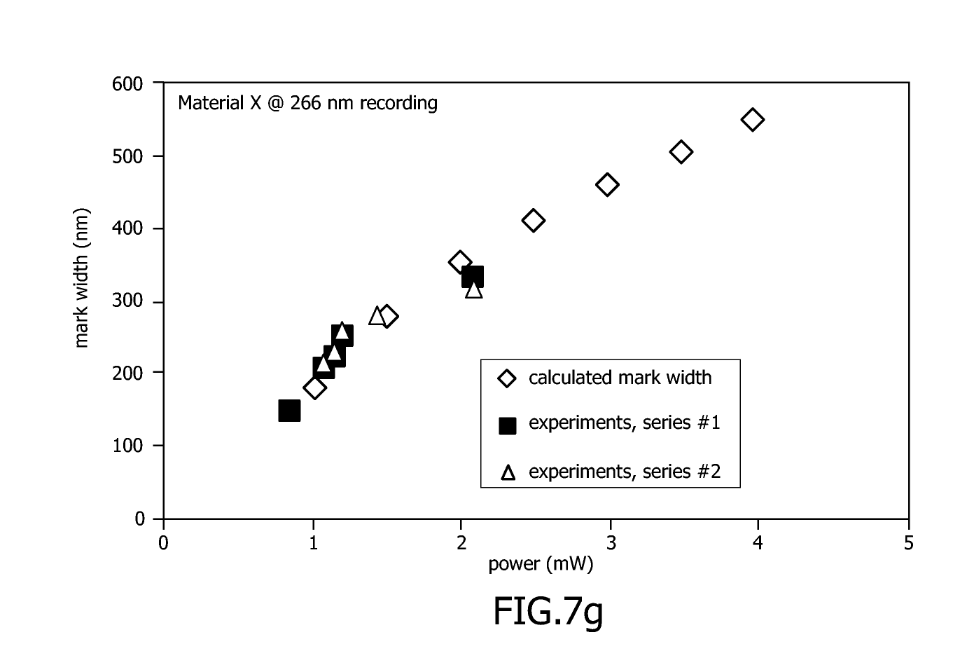

FIGS. 7a to 7c show a seventh embodiment of a master substrate 12 in accordance with the present invention during processing by a method in accordance with the invention, wherein FIG. 7a shows the master substrate 12 untreated, FIG. 7b shows the master substrate 12 after writing, and FIG. 7c shows the master substrate 12 after etching.

In accordance with embodiment 7 the recording stack 10 comprises a dielectric layer 14 made of ZnS—SiO₂. Furthermore, there is provided an optional mirror layer 32 and an also optional covering layer 38. The covering layer 38 is preferably as thin as possible, is present during writing, and is chemically removed via etching. Its function is to prevent the absorption layer to chemical degradation, and not enhance the absorption properties.

With the master substrate of FIG. 7a the method in accordance with the invention can be carried out as follows:

First, a recording stack 10 comprising the dielectric layer 14 (and also the mirror layer 32 and the covering layer 38) is provided.

Then, a heat induced phase transition in region 22 of the dielectric layer 14 is caused where a pit 24 is to be formed by applying laser pulses having a wavelength of 257 nm.

Finally, the region 22 of the dielectric layer 14 which has experienced a phase transition is removed by an etching process.

FIGS. 7d and 7e show sectional analyses of the results of practical experiments made on the basis of a master substrate in accordance with FIGS. 7a to 7c. Recording of ZnS—SiO₂ was performed at 266 nm wavelength, i.e. a deep UV laser wavelength. In particular, experiments with a 266 nm laser beam recorder showed excellent absorption, meaning that moderate laser powers are required to achieve the transition temperature, and excellent selective etching performance. A typical result is given in FIG. 7d: A 50 nm ZnS—SiO₂ layer was sputter-deposited on a glass substrate. A 266 nm laser beam recorder was used to write marks in the ZnS—SiO₂ layer. Laser powers of about 1 mW are required to induce a temperature rise of about 750-900° C. The recorded layer was treated with a 0.5% HNO₃ solution to remove the unwritten parts of the layer. An example of a recorded and etched 80 nm ZnS—SiO₂ layer is given in FIG. 7e, wherein illumination was again performed with a 266 nm LBR and the recorded layer was treated with 0.25% HNO₃ solution to selectively etch the layer. The Atomic Force Microscopy pictures of FIGS. 7d and 7e illustrate the high contrast that can be achieved with ZnS—SiO₂ as PTM material.

As shown in FIG. 7f, Differential Scanning Calorimeter (DSC) measurements were performed to obtain information on the phase transition upon the ZnS—SiO₂ material becomes inert for HNO₃ etching. Based on recording experiments it is expected to be around 800° C. However, the phase transition from zinc blende to wurtzite happens at a temperature of 1020° C. in the bulk material; for that reason the experiment was done in a broad temperature range from 20° C. to 1200° C., with a constant heating rate of 10° C./min (TEMP curve). Two different samples of ZnS—SiO₂ were tested: one sample consisted of ZnS—SiO₂ powder obtained from a sputtering target and of powder obtained from sputter-remainders. A nitrogen flow was maintained inside the chamber to minimize oxidation of the sample. The DSC results of FIG. 7f are given for the as-deposited ZnS—SiO₂ powder. No clear change in heat flow is observed but a clear drop in mass is found at 650° C. and 800° C. The heat flow (DSC curve) increased in time; the total mass show two clear drops around 650° C. and 800° C. (TG curve).

The phase-transition temperature of 800° C. is in agreement with recording experiments. Marks were written in a 50 nm ZnS—SiO₂ layer at different recording powers and subsequently etched with HNO₃. The mark widths were measured with AFM, these results are given in FIG. 7g. In addition, a three-dimensional simulation tool was used to predict the mark width. The thermal conductivity, heat capacity and optical properties of the ZnS—SiO₂ recording stack and the writing conditions (such as laser power, recording velocity, optical spot size, etc.) were input to the model. Simulation results for a phase-transition temperature of 800° C. are also indicated in FIG. 7g. Therefore, FIG. 7g shows a comparison between calculated and measured (AFM) full width half maximum widths of recorded and etched marks written in an 80 nm ZnS—SiO₂ layer (266 nm wavelength, N.A.=0.9). A good agreement between simulations and experiments is particularly found in the power range 0.5-1.5 mW. With lower power values than 0.5 mW, the light absorption in many cases is not sufficient for writing in the 80 nm ZnS—SiO2 layer at 266 nm. This good agreement between the simulations and experiments indicates that marks are recorded around 800° C. in ZnS—SiO₂.

### Embodiment 8

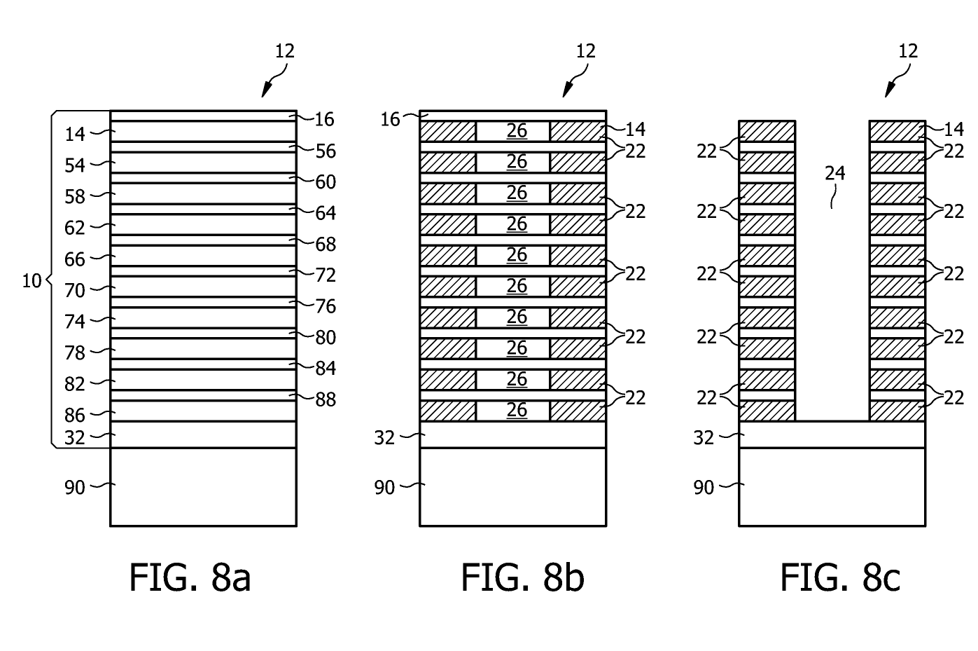

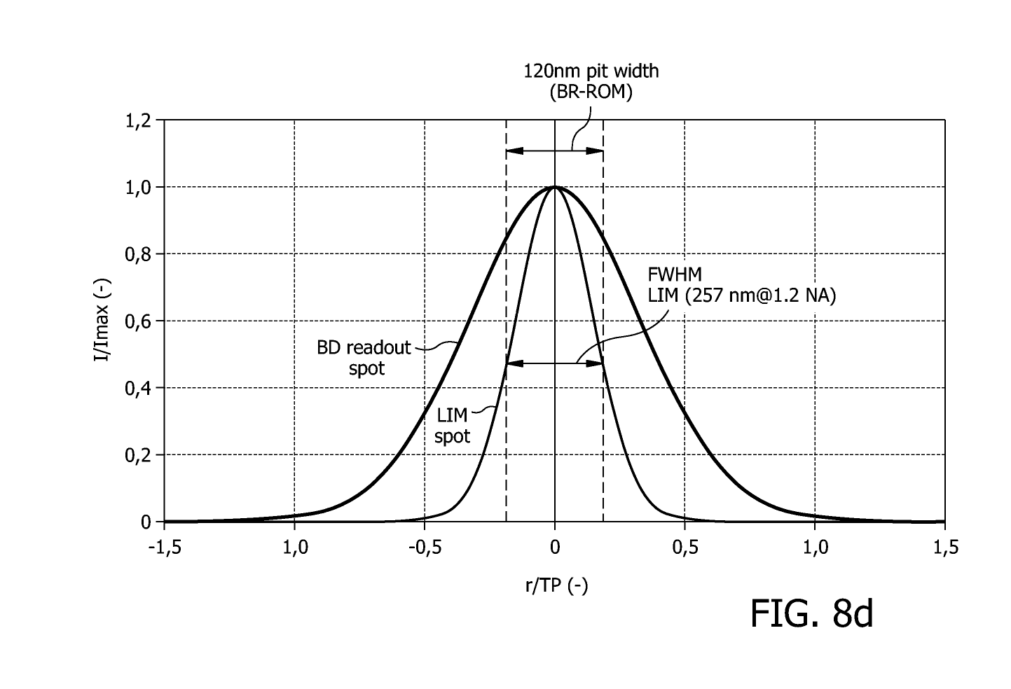

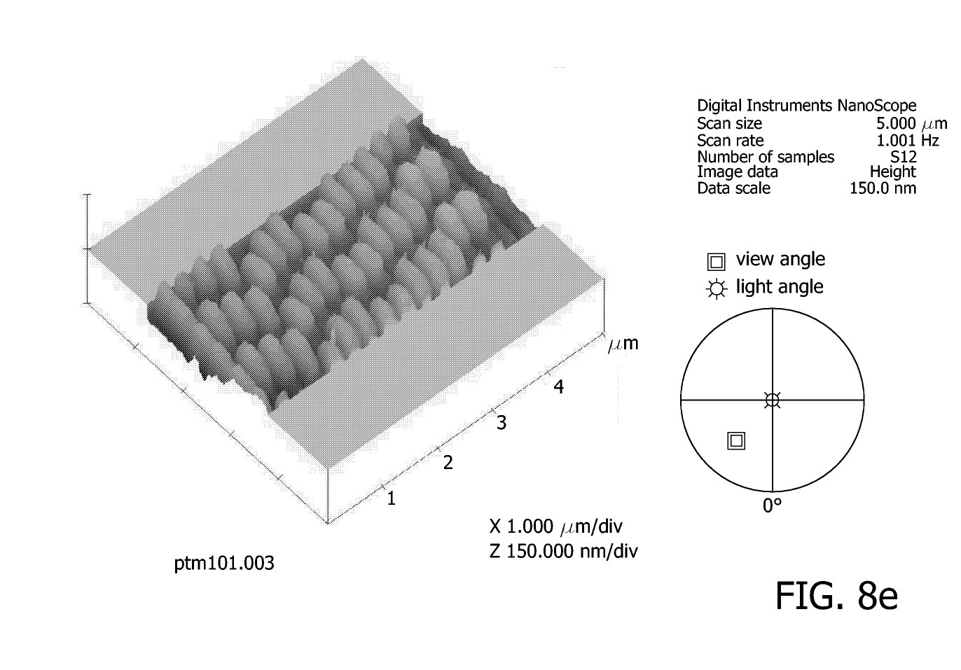

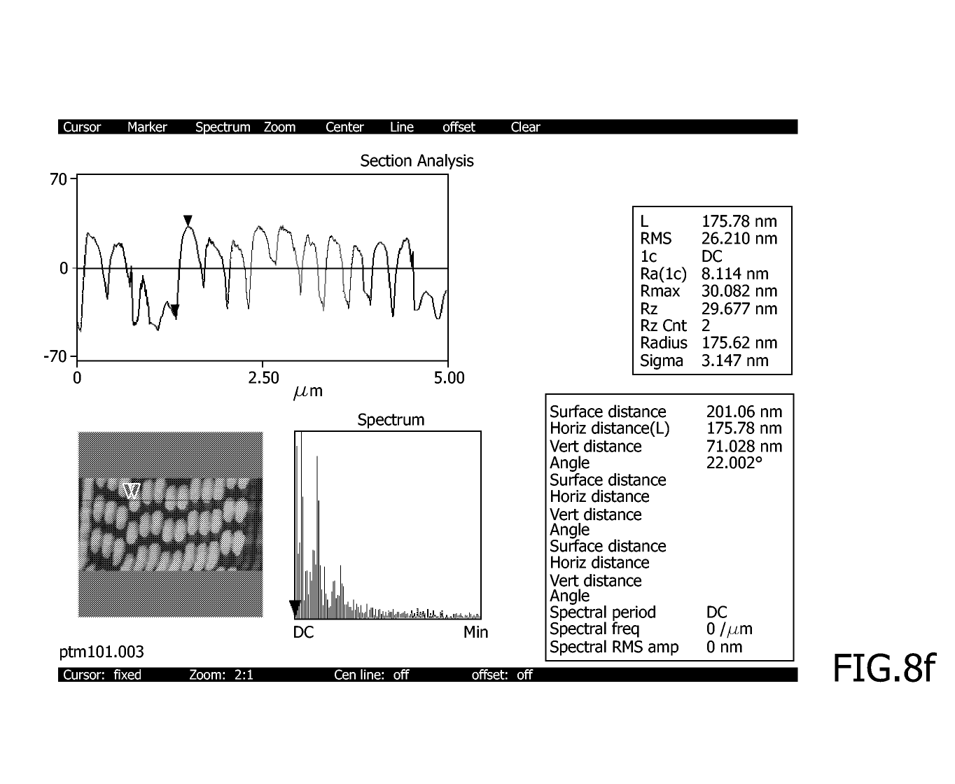

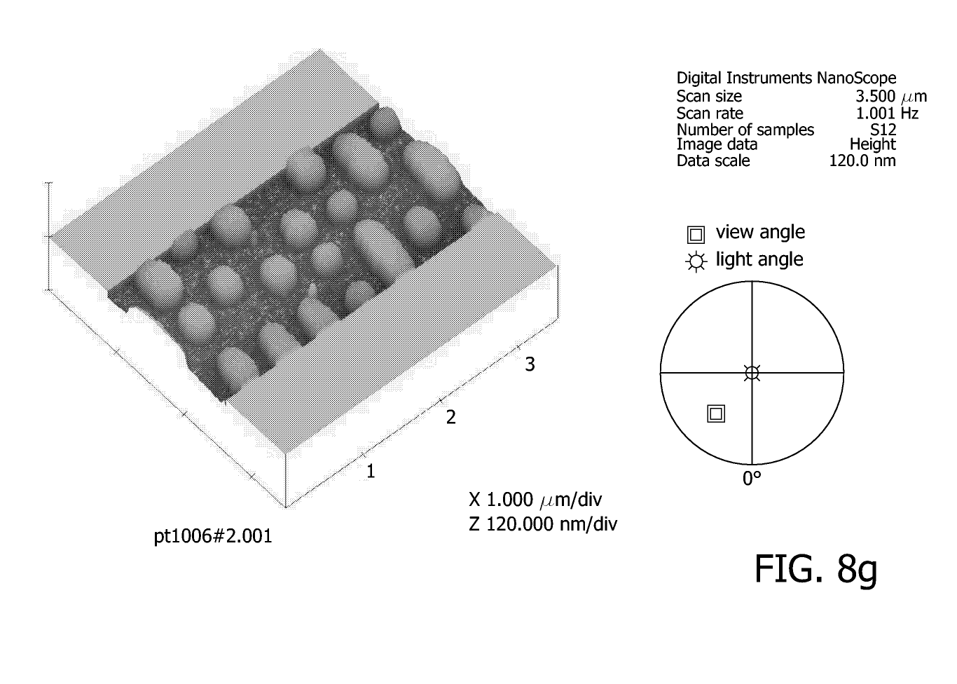

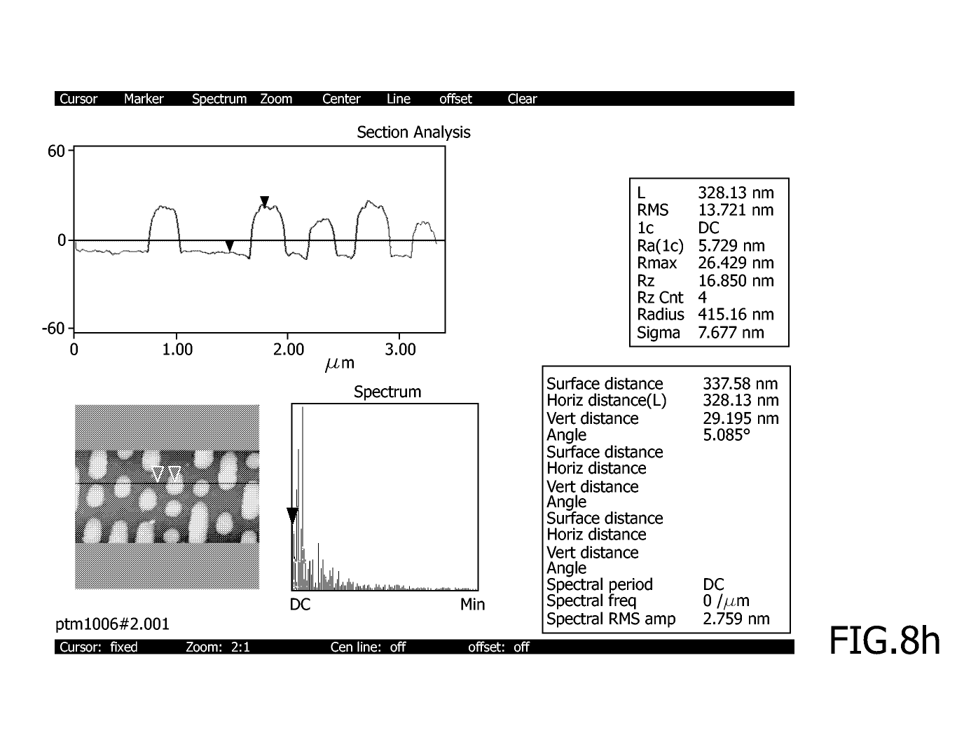

FIGS. 8a to 8c show an eighth embodiment of a master substrate 12 in accordance with the present invention during processing by a method in accordance with the invention, wherein FIG. 8a shows the master substrate 12 untreated, FIG. 8b shows the master substrate 12 after writing, and FIG. 8c shows the master substrate 12 after etching.

The recording stack 10 of the master substrate 12 comprises a substrate 90 which can, for example, be a glass substrate or a pre-grooved polycarbonate substrate. On the substrate 90 there is provided a mirror layer 32 for improving the reflection of the recording stack 10. The mirror layer 32 is optional and can be made out of metals like Ag, Al, Si, etc. As long as the layer below the dielectric layer 14 is unetchable by the used etchant, it can be used. This can be the substrate itself, but an added mirror layer 32 improves the overall stack efficiency and makes the bottom surface of the pit 24 smoother.

The recording stack 10 of the master substrate 12 comprises numerous pairs of ZnS—SiO₂, a selectively etchable dielectric material, and SnGeSb absorption layers. These absorption layers can be selectively or unselectively etchable. In detail, the illustrated recording stack 10 comprises 10 pairs of 5 nm ZnS—SiO₂ and 1 nm SnGeSb phase-change layer provided, i.e. 20 alternating dielectric 14, 54, 58, 62, 66, 70, 74, 78, 82, 86 and absorption layers 16, 56, 60, 64, 68, 72, 76, 80, 84, 88. The SnGeSb absorption layers are, for example, used to indirectly heat the ZnS—SiO₂ dielectric layers when exposed to blue (405 nm) laser light (ZnS—SiO₂ has hardly no absorption for 405 nm laser wavelength). The heat induces a phase-change in the ZnS—SiO₂ dielectric layer. The ZnS—SiO₂ layer exhibits selective etching upon laser-induced heating, thereby creating a relief structure after etching. The written state has a much lower etch rate when exposed to chemical reactants, like the acids mentioned above, than the initial unwritten state such that a bump structure remains after etching. If necessary, a covering layer can be used to prevent oxidation or material shifts due to melting (not shown in FIGS. 8a to 8c). Such a covering layer can be made of an etchable dielectric or organic layer and should be as thin as possible. As an etchant, acid solutions like HNO₃, HCl, H₂SO₄ or alkaline liquids like KOH and NaOH can be used.

With the master substrate 12 of FIG. 8a the method of the invention can be carried out as follows:

First, the recording stack 10 shown in FIG. 8a and comprising ten dielectric layers 14, 54, 58, 62, 66, 70, 74, 78, 82, 86 and means 16, 56, 60, 64, 68, 72, 76, 80, 84, 88 for supporting heat induced phase transitions within the dielectric layers 14, 54, 58, 62, 66, 70, 74, 78, 82, 86 is provided.

Then, heat induced phase transitions are caused in the regions 22 of the dielectric layers 14, 54, 58, 62, 66, 70, 74, 78, 82, 86 where the pit 24 (FIG. 8c) is not to be formed by applying laser pulses. The result is shown in FIG. 8b.

Finally, the first absorption layer 16 and the regions 26 of the dielectric layers 14, 54, 58, 62, 66, 70, 74, 78, 82, 86, which have not experienced a phase transition, are removed together with the adjacent parts the absorption layers 16, 56, 60, 64, 68, 72, 76, 80, 84, 88 by an etching process. The result is shown in FIG. 8c.

With practical experiments, a recording stack that comprised 10 pairs of 5 nm ZnS—SiO₂ and 1 nm SnGeSb phase-change layer provided a well-defined pit structure after etching. With one practical experiment, the recording stack was sputter-deposited on a glass substrate. Bumps and grooves were written with a laser beam recorder (first surface recording, NA=0.9, 405 nm wavelength). With another practical experiment, the recording stack was sputter-deposited on a pre-grooved polycarbonate substrate. This substrate was recorded on a Pulstec with an additional cover layer (second surface recordings, NA=0.85, 405 nm wavelength). The written discs were treated with HNO₃ acid solution. The glass sample exposed with a LBR was directly etched. For the polycarbonate sample with recording stack, the cover layer was removed prior to etching. Recording powers ranged between 3 and 5 mW for both types of test samples illustrating that the thin absorption layers introduced indeed absorption in the recording stack. Laser induced heating of the recording stack caused partial crystallization of the as-deposited amorphous phase-change absorption layers. Written data tracks were clearly visible prior to etching. Such a detectable phase-change is of eminent importance if the material is used in combination with a 405 nm laser. In that case, only the top of the focused laser spot is used for writing, making the system very sensitive for power variations. A visually detectable phase change enables the use of the read back signal of the written marks to control the laser write power. This is better known as DRAW (=Direct Read After Write). This is illustrated in FIG. 8d in which the targeted pit size for a 25 GB BD-ROM is given in addition to the focused intensity profiles of two different laser beam recorder systems. The BD readout spot curve corresponds to a blue system with NA=0.85 and 405 nm wavelength, the LIM spot curve corresponds to a spot obtained with liquid immersion mastering (NA=1.2 and 257 nm wavelength). It is seen that the LIM spot is sufficiently small in order to write the pit with the Full-Width Half Maximum (FWHM) of the laser spot. In that case, the obtained pit width is less sensitive to power variation. In case a blue laser spot is used to write a BD-ROM pit, only the top of the spot is used. In that case, power control is very important since the obtained pit width is very sensitive to power fluctuation or inhomogeneities in the master substrate. Although the recording stack comprised 20 layers (10 pairs of 5 nm ZnS—SiO2 and 1 nm SnGeSb), the dissolution was rather uniform. It seems that the 1 nm thick phase-change films were not clear interfaces on which the total layer could break.

A surface analysis and a sectional analysis of bumps written in the above mentioned stack that was sputter-deposited on the polycarbonate pre-grooved substrate (to enable writing with a Pulstec recorder) is given in FIG. 8e and FIG. 8f, respectively. The recorded stack was treated with 5% HNO₃ acid to dissolve the initial unwritten material. The bump structure is characterized by steep walls and thus a high contrast. The bumps are written at a data track pitch of 320 nm, illustrating the size of the bumps.

A surface analysis and a sectional analysis of bumps written in the above mentioned stack that was sputter-deposited on the glass substrate is given in FIGS. 8g and 8h, respectively. The structure was obtained with a laser beam recorder (first surface recording, 405 nm, NA=0.9). The marks were written at 500 nm track-pitch. The recorded disc was treated with 5% HNO3 acid.

It is to be noted that equivalents and modifications not described above may also be employed without departing from the scope of the invention, which is defined in the accompanying claims.

### Embodiment 9

This embodiment is directed to the growth control of the ZnS nanocrystal size by an annealing process. As already mentioned above, at room temperature, a ZnS—SiO₂ film contains tiny nanosized ZnS particles embedded in a SiO₂ matrix, wherein the size of the nanocrystals is temperature dependent: increasing the temperature initiates a growing in size of the nanocrystals. This leads to a blue-shift in the light absorption range of ZnS—SiO₂. Scattering of blue light through the nano-composite material is assumed to be the main reason for this blue-shift. An annealing process initiates at least the following three effects inside sputtered as-deposited ZnS—SiO₂:

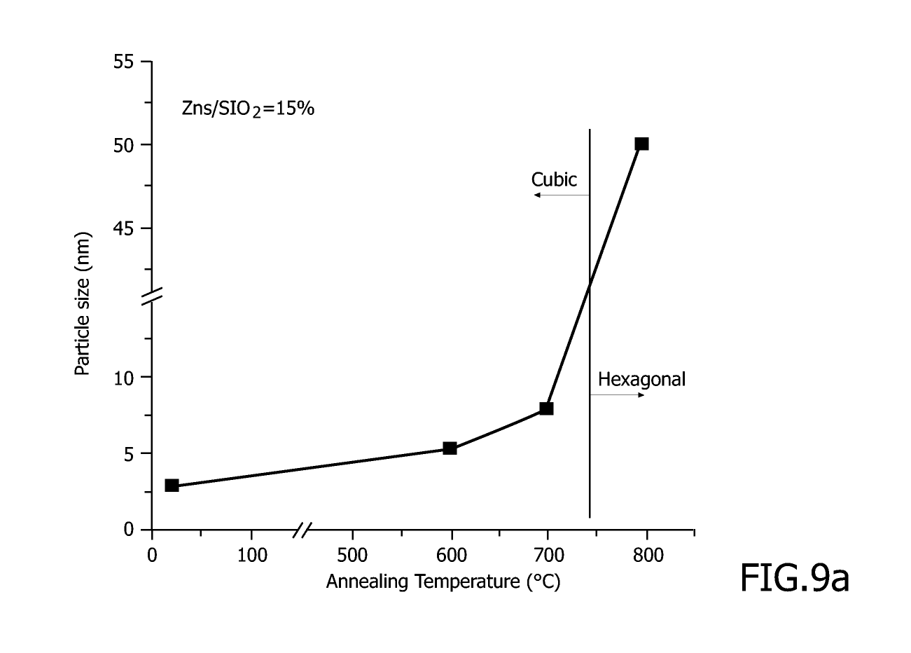

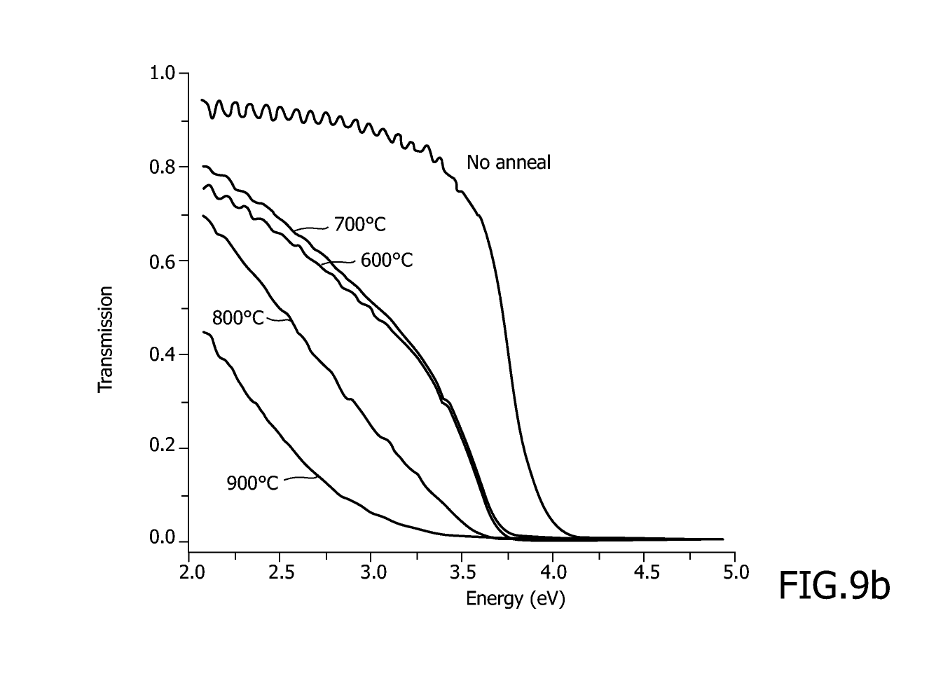

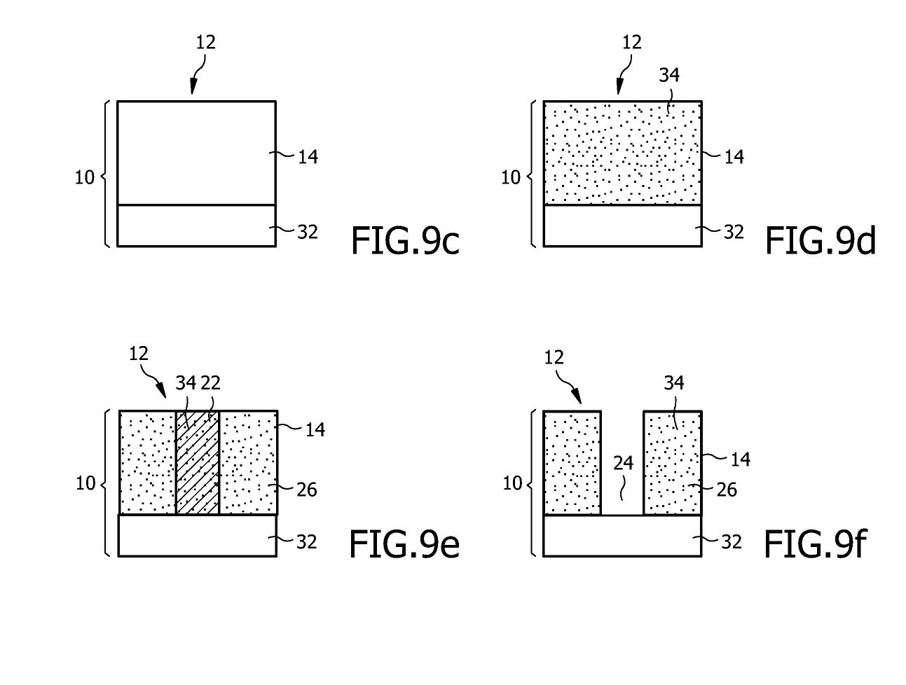

1.) The size of the nanocrystals is about 2 nm at room temperature and increases up to 50 nm at 800° C. The size of the nanocrystals is responsible for light absorption at a specific wavelength: the smaller the nanocrystal size the smaller the wavelength absorbed. For that reason, it is possible to tune the light absorption spectrum with the growth of the nanocrystal size with temperature. As can be seen in FIG. 9a, the size of the nanocrystals rapidly increases for annealing temperatures higher than 700° C. due to the rapid increase in the bulk diffusion coefficient. FIG. 9b shows the transmission spectra of nano-composite samples with high-content ZnS (15% mol). A blue wavelength of 405 nm corresponds to a photon energy of 3.0 eV. At room temperature, the drop in transmission occurs at a wavelength of 310 nm, as it is known as such.
2.) A cubic to hexagonal (sphalerite to wurtzite) phase transition occurs between 700° C. and 800° C. in the ZnS nano-particles (see FIG. 9a). This should be compared to the bulk transition temperature that is 1020° C. This change is probably due to nano-size effects. The phase change may be responsible for the selective etching with acids.
3.) At 900° C., some parts of the ZnS molecules oxidize to ZnO and then react with SiO₂ to form Zn₂SiO₄. Thus, the surfaces of the nanocrystals are passivated and stabilized against chemical attacks such as wet etching with acids. Thus, this step may also be responsible for the selective etching.

In summary, heating, for example, a thin layer of sputter-deposited ZnS—SiO₂ in an oven to 700° C. will cause a blue-shift, enabling the direct recording of marks. When such an annealing step is provided, additional absorption layers or doping at least in some cases are not necessary for recording marks in the ZnS—SiO₂, for example with a 405 nm laser beam recorder. FIGS. 9c to 9f schematically show such a method applied to a further embodiment of a master substrate in accordance with the present invention, wherein FIG. 9c shows the master substrate 12 untreated, FIG. 9d shows the master substrate 12 after an annealing step, FIG. 9e shows the master substrate 12 after writing, and FIG. 9f shows the master substrate 12 after etching.

With the embodiment illustrated in FIGS. 9c to 9f the recording stack 10 of the master substrate 12 comprises a dielectric ZnS—SiO₂ layer 14. Under the dielectric layer 14 there is provided an optional mirror layer 32.

In the untreated condition shown in FIG. 9c the ZnS—SiO₂ layer contains nanocrystals which at room temperature have a size of about 2 nm, i.e. which are very small and are therefore not shown in FIG. 9c.

FIG. 9d shows the master substrate 12 after it was heated in an oven to about 700° C. By this annealing process the size of the nanocrystals 34 in the ZnS—SiO₂ layer increased to about 7.5 nm.

FIG. 9e shows the master substrate 12 after writing, i.e. after laser pulses having a wavelength of 405 nm were applied to a region 22 where a pit is to be formed.

FIG. 9f shows the master substrate 12 after etching. As may be seen, the material in the region 22 was removed and the pit 24 was formed.

### Embodiment 10

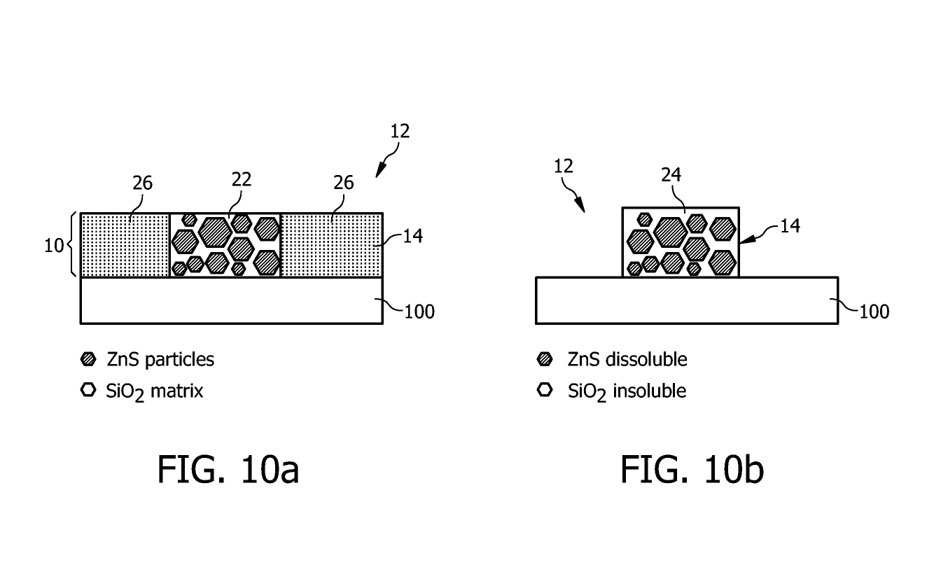

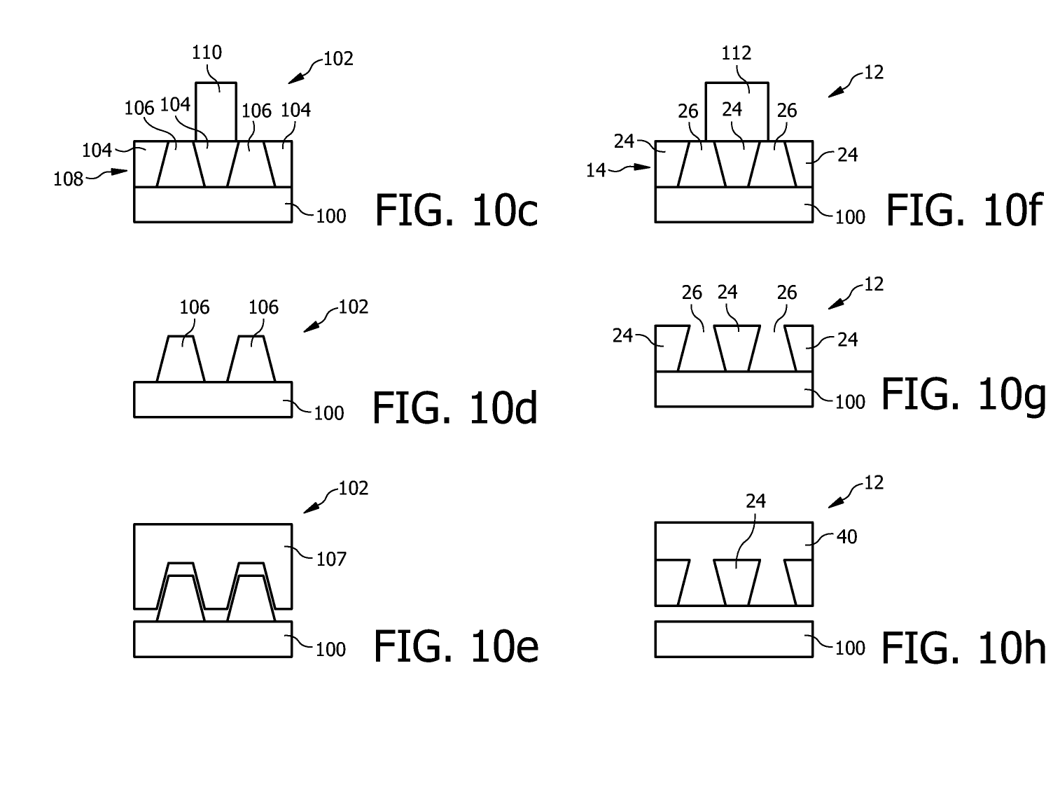

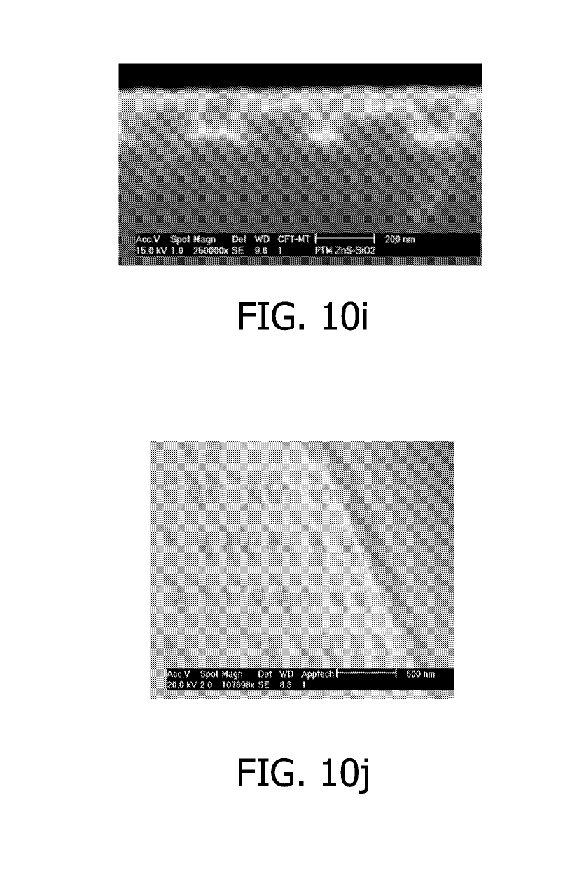

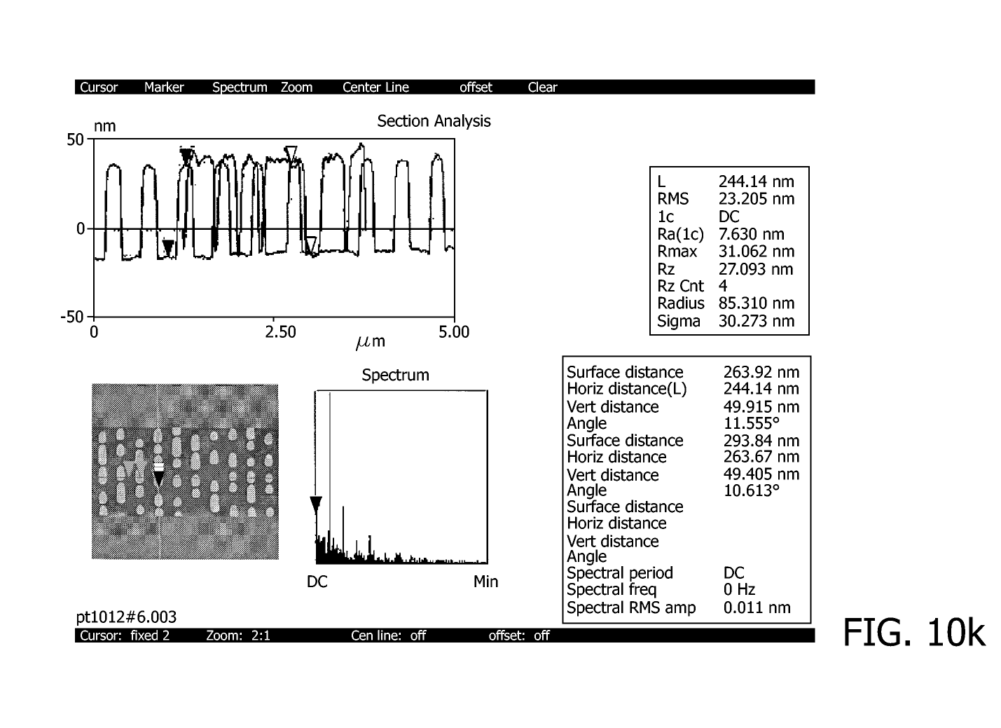

FIGS. 10a and 10b schematically show the marking mechanism in a dielectric layer 14 of a master substrate 12. The master substrate 12 comprises a recording layer 10 having a single dielectric layer 14 of ZnS—SiO₂ deposited on a glass substrate 100. FIG. 10a shows the master substrate 12 after a writing process, i.e. after applying laser pulses of a 266 nm laser beam recorder onto the dielectric layer 14. The ZnS particles are significantly larger in the recorded area 22. After wet etching of the recorded layer, the recorded material remains as a bump structure on top of the substrate. The dielectric layer 14 comprises regions 26, where no laser pulses were applied, and regions 22, which have been exposed to laser light energy. The light energy applied to the region 22 is absorbed inside the dielectric layer 14 and transferred into heat. The initially unrecorded (unwritten) regions 26 comprise small sizes of ZnS particles in a SiO₂ lattice. After the writing process the ZnS particles in the recorded area 22 are significantly larger than the particles in the unwritten area 26. FIG. 10b shows the master substrate 12 after a wet etching process. The unrecorded areas 26 of the master substrate 12 are removed and the recorded material in the regions 22 remains as a bump structure 24 on top of the glass substrate 100.

FIGS. 10c to 10h show a comparison of stamper growing with a conventional resist master (FIGS. 10c to 10e) and with a ZnS—SiO₂ PTM master (FIGS. 10f to 10h). In FIG. 10c a conventional photo resist 108 on a glass substrate 100 is illuminated with a laser light beam 110. The light absorption process causes in vertical direction a characteristically conical shape, narrowing in beam direction. As can be seen in FIG. 10d, the exposed areas 104 are removed by an etching process forming conical shaped pits 106. In FIG. 1e a nickel stamper 107 is grown from the developed master 102 showing taper-shaped bumps. The stamper 107 enables mass replication via injection moulding. FIG. 10f shows the opposite marking process encountered in ZnS—SiO₂ mastering. A dielectric layer 14 (ZnS—SiO₂) deposited on a glass substrate 100 is illuminated with a laser light beam 112. The laser light of the laser beam 112 is absorbed inside the ZnS—SiO₂ layer 14 resulting in a sequence of exposed 24 and unexposed 26 areas (FIG. 10f). After wet etching (FIG. 10g), an inverse bump/pit shape 24, 26 compared with the conventional photo resist process is obtained such that conical bumps 24 remain with the clear possibility of underetching. The inverse polarity of ZnS—SiO₂ PTM masters is problematic for stamper growing, since the separation of the dovetail connection between the grown stamper 40 and the relief structure of the bumps 24 can be made impossible (see FIG. 10h).

FIG. 10i shows a SEM Scanning Electron Microscopy picture of bumps written in a Ni—ZnS—SiO₂ stack (processing: 15 min @ 1% HNO₃). FIG. 10j shows bumps written in a 80 nm ZnS—SiO₂ stack with a 266 nm LBR (processing: 120 s @ 0.06% HNO₃).

FIG. 10k shows the results of an AFM scan of a bump structure showing underetching features. An 80 nm ZnS—SiO₂ layer sputter-deposited on a glass substrate was recorded with a 266 nm laser beam recorder (numerical aperture of 0.9). 17PP data with block pulses was random data recorded at a linear velocity of 2 m/s with powers from 75 to 115 ILV. The disc was treated for 50 s in 0.25% HNO₃, revealing the embossed data pattern on the surface of the master. An AFM scan of the obtained bump structure is given in FIG. 10k. The bumps are 80 nm in height, which equals the initial recording layer. The measured wall angle of 75° indicates the possibility of underetching. Since a typical AFM tip has a tip angle of about 75° (which corresponds to a top angle of 30°), it is impossible to measure feature wall angles larger than 75° in a perpendicular orientation. This indicates the possibility of underetching.

FIG. 10l shows the results of an AFM scan of a stamper grown on the bump structure of FIG. 10k. A thin layer of 100 nm Nickel was sputter deposited on the data side and electroplating was performed. An AFM picture of the separated stamper is shown in FIG. 10k. The pits in the stamper have a minimum depth of 5 nm, a maximum depth of 20 nm and a mean depth of 6.5 nm. The mean Ra surface roughness is between the tracks is about 0.5 nm, Rms equals 0.65 nm. The pits show a stair shape and the deepest part of a pit is where the mark is narrowest. The unwritten part of the substrate was fully developed and separates easily from the stamper. These results indicate the pits being filled with ZnS—SiO₂ remainders from the embossed pattern of the master due to underetching.

For example, the inverse polarity processing as described in relation to embodiment 10 in some cases might suffer from the problem of underetching. Possibly, this problem will also occur in connection with other embodiments. The following embodiments 11 to 15 particularly address the problem of underetching, in order to improve the shape of the written and developed structures after wet etching processes.

### Embodiment 11

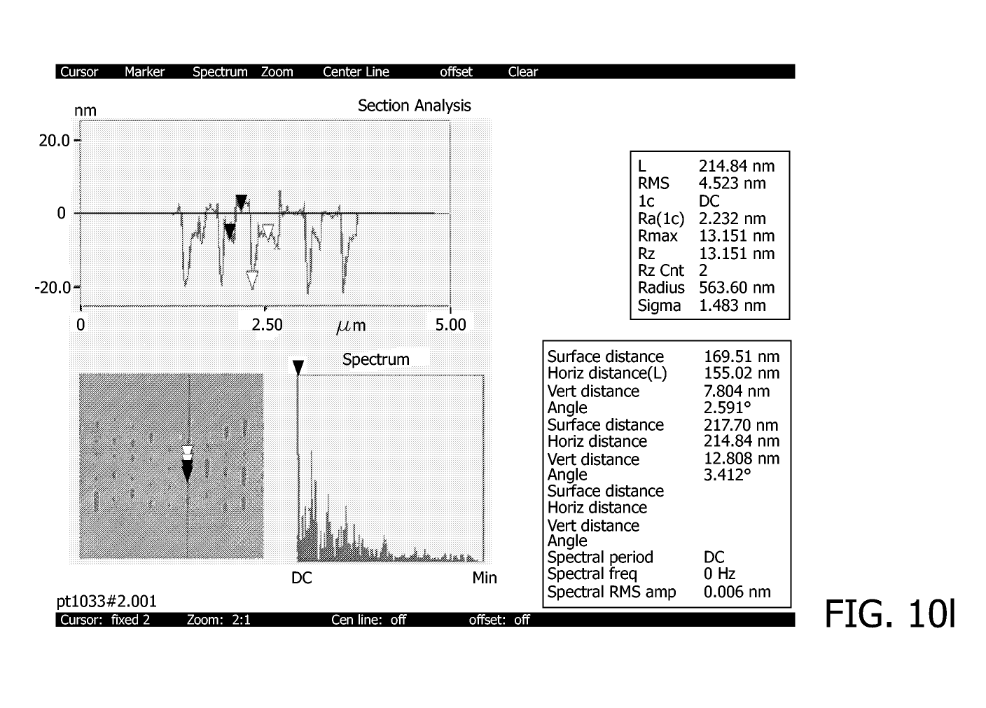

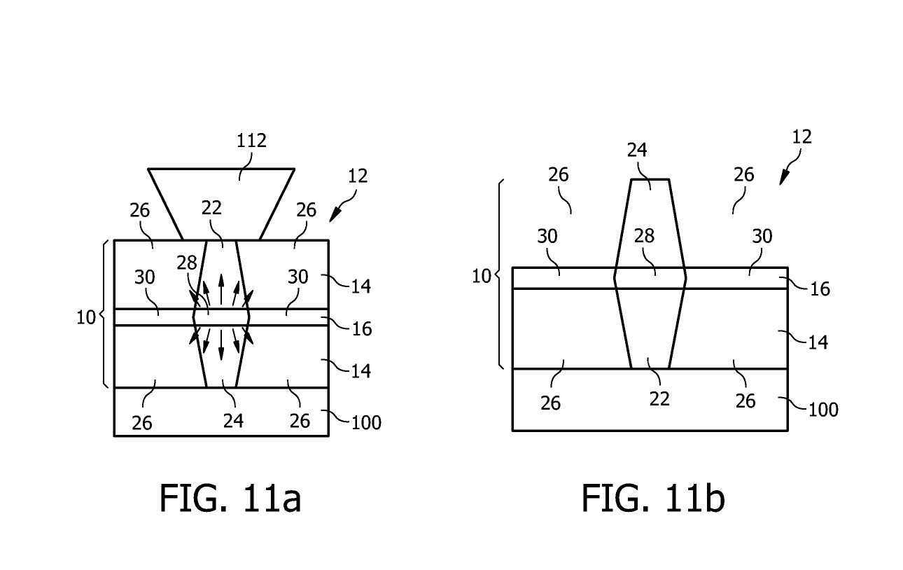

FIGS. 11a and 11b show a eleventh embodiment of a master substrate 12 in accordance with the present invention during processing by a method in accordance with the invention, wherein FIG. 11a shows the master substrate 12 during writing and FIG. 11b shows the master substrate 12 after etching.

The recording layer stack 10 of the master substrate 12 comprises two dielectric layers 14 of ZnS—SiO₂ enclosing an absorption layer 16. The recording layer stack 10 is arranged on a glass substrate 100. Possible absorption layer materials are SbTe, Si, Ag, Al, etc. When the dielectric layer 14 is to fully developed (up to the absorption layer), the absorption layer should be etch-resistant. Absorption layers 16 can be added to the recording stack 10 to induce an extra heat flow from below. Heat is generated in the absorption layer as well, in that way improving the bump shape. After exposure to HNO₃ bumps with a taper-like profile remain.

### Embodiment 12

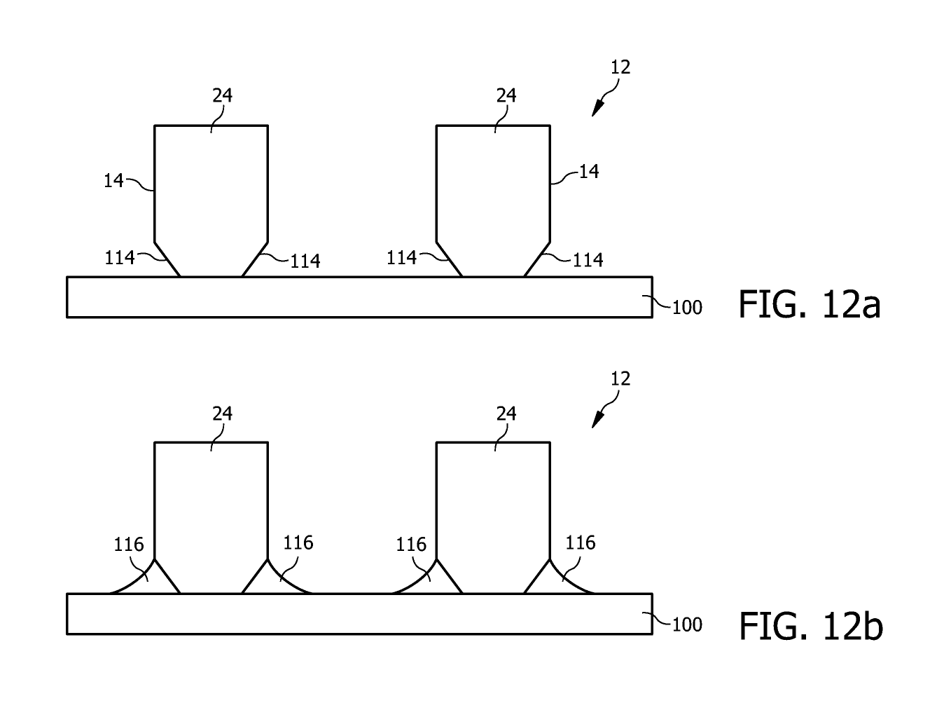

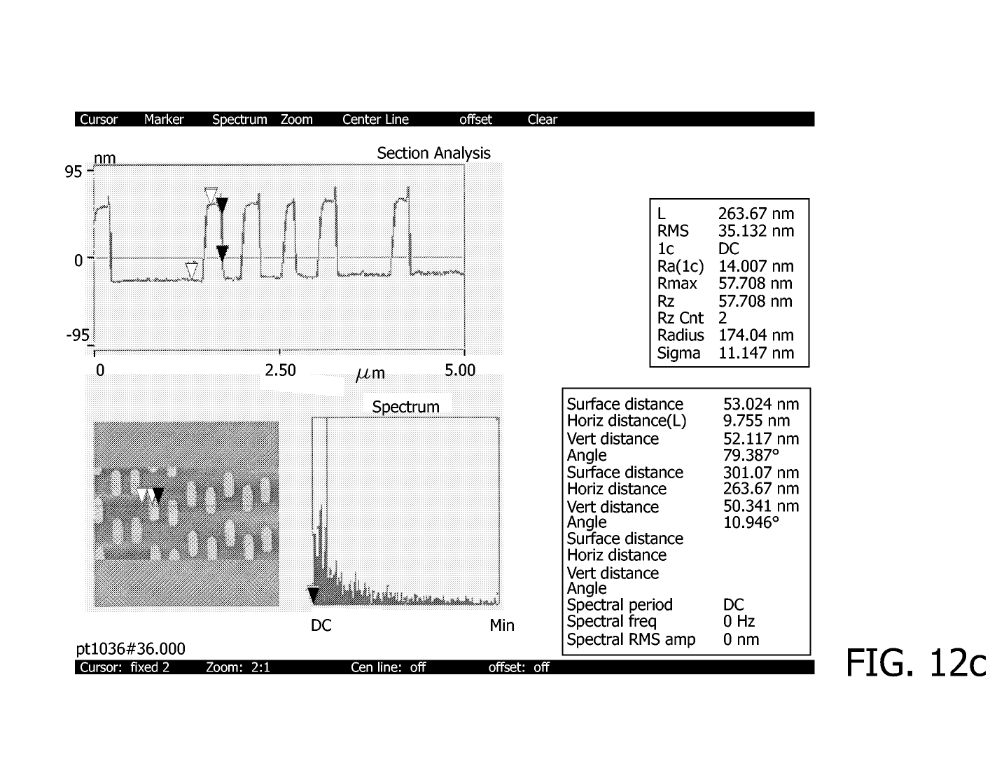

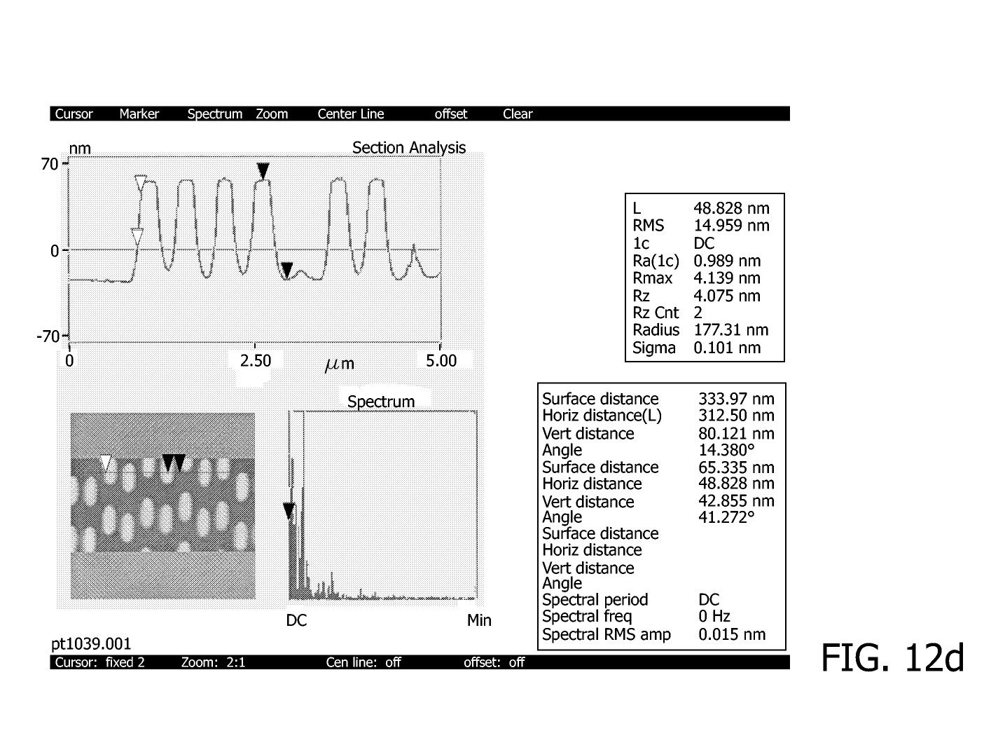

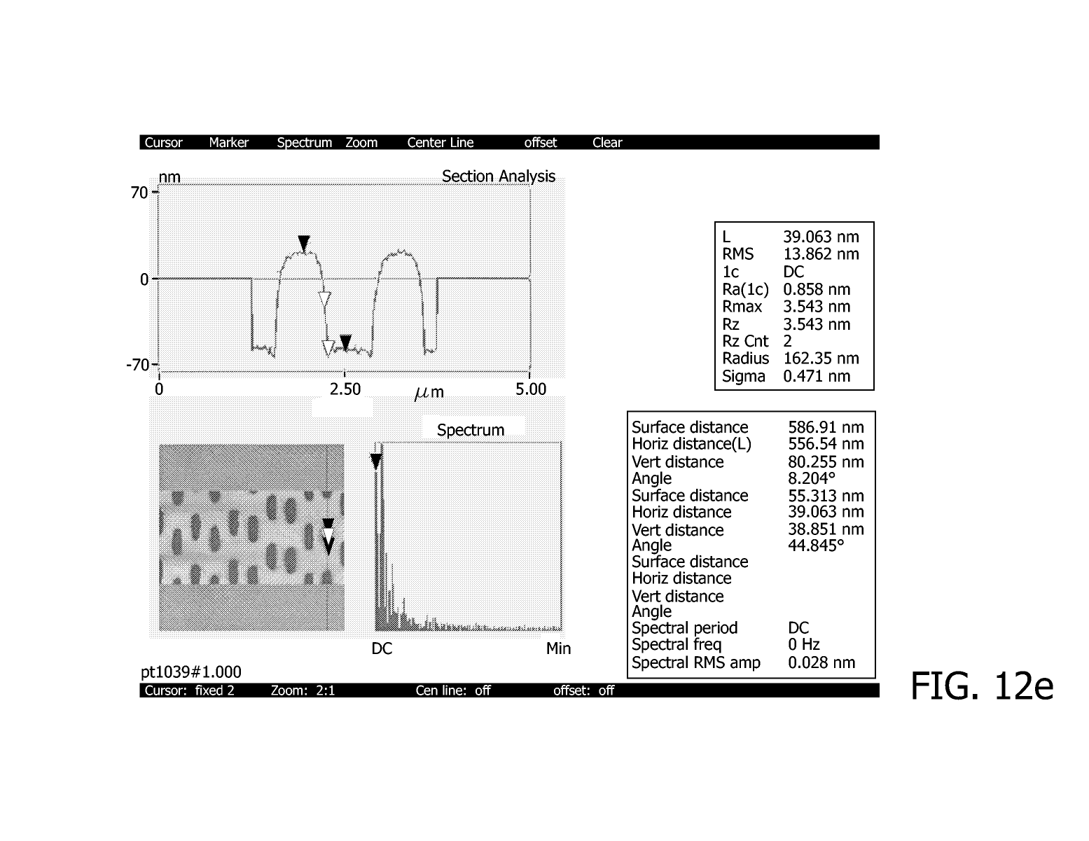

FIGS. 12a and 12b show a twelfth embodiment of a master substrate 12 in accordance with the present invention during processing by a method in accordance with the invention, wherein FIG. 12a shows the master substrate 12 after etching and FIG. 12b shows the master substrate 12 after spin-coating with silane.

FIG. 12a shows schematically the written and developed master substrate 12 comprising a single developed dielectric layer 14 deposited on a glass substrate 100. The master substrate 12 was fully developed and shows regions 114 of underetching. The developed master substrate 12 was covered with a silane film (or other spin-coated organic film) to fill the underetched regions. In FIG. 12b a silane film 116 (SiₙH₂ₙ₊₂) was spin coated and filled the underetched regions 114 due to capillary forces. The capillary forces will make the polymer layer remain in the underetched parts 114 of the bumps 24 and improve in that way the bump 24. Besides silane also other organic or polymeric material may be employed. The cavities of the underetched regions 114 are filled and the vertical bump shape is improved.

FIGS. 12c and 12d show the results of an AFM analysis of a silane treatment of a master substrate 12. Silane was spin-coated on a 80 nm ZnS—SiO₂ layer of a 12 cm glass master at a rotation speed of 200 rpm. The substrate was subsequently dried at 1500 rpm to remove the silane excess. FIG. 12c shows the AFM results of 8T carriers written in an 80 nm ZnS—SiO₂ layer before the silane treatment, FIG. 12d after the silane treatment. A significant difference in the bump shape can be seen. Without silane treatment the walls show the AFM tip angle of 75°, as already discussed above, with silane treatment the walls are less steep at an angle of 45°. The measure height of 80 nm supports the idea of silane only remaining on the walls of the bumps 24 and underneath the bumps 24 in the underetched regions 114. The silane in between the bumps 24 is forced out due to centrifugal forces during the spin-coating and the drying.

FIG. 12e shows the results of an AFM analysis of a stamper grown on a silane treated master substrate 12. A stamper was grown from the above discussed (FIG. 12d) master substrate. The separation of the stamper and the master substrate was only observed to be good in the inner parts of the disc. The AFM analysis reveals pit depth of 80 nm and a wall angle of about 45°. The asymmetric pit shape as observed from is presumably caused by the spin coating of silane. Bumps on the master substrate act as flow obstructers when the silane is driven by centrifugal forces from the inside to the outside of the master substrate. Silane will then accumulate in front of the bump while there is less silane in its wake.

### Embodiment 13

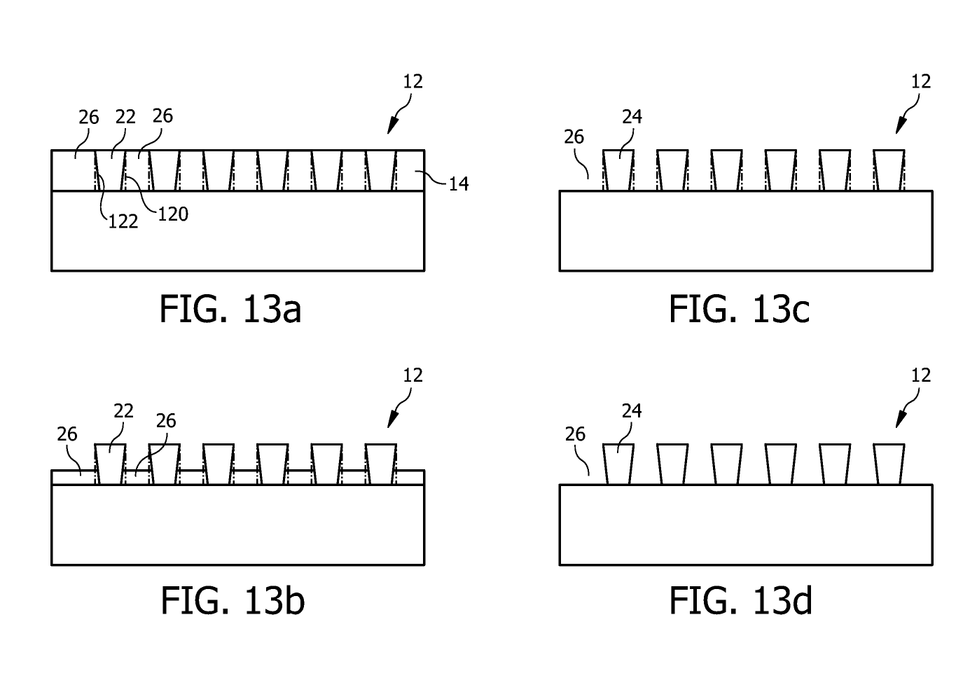

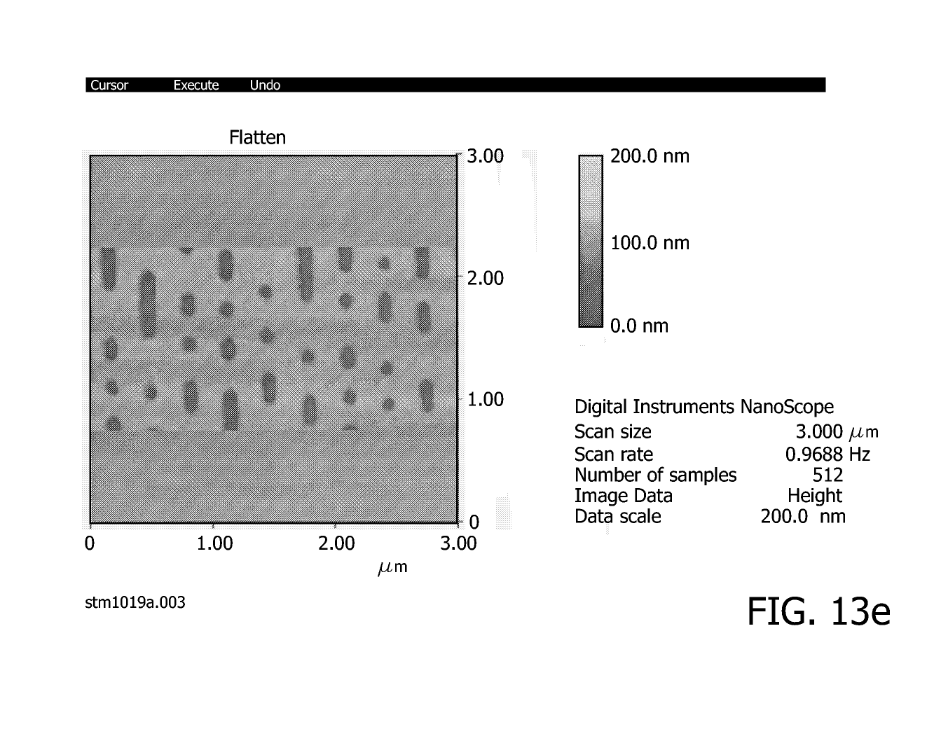

FIGS. 13a to 13d show a thirteenth embodiment of a master substrate 12 in accordance with the present invention during processing by a method in accordance with the invention, wherein FIG. 13a shows the master substrate 12 after writing, FIGS. 13b, 13c, and 13d show the master substrate 12 at different etching stages. The basic idea of embodiment 12 is to stop the etching process of the dielectric layer 14, before the master substrate is completely developed thus avoiding underetching. Well controlled development conditions may prevent the occurrence of underetching. If the master is too long exposed to the etching liquid, the bump may suffer from underetching. If the master is overexposed, underetching may occur. If the etching process is well controlled, a predetermined depth can be obtained. In that case, underetching is prevented.

In FIG. 13a the master substrate 12 is recorded and shows a written relief structure 22 as well as unwritten regions 26 in the dielectric layer 14. The dotted line 120 indicates the intended wall shape, whereas the line 122 shows the shape of the bumps after a complete development or after an overexposing of the master substrate 12. In FIGS. 13b and 12c stages of the etching process are shown, where the bump shape is still in a desired range, i.e. no underetching has occurred, In FIG. 13d, the underetching is already present. In order to utilize the stages of the FIG. 13b or 13c, the etching process has to be well controlled.

FIG. 13e shows the results of an AFM analysis of a stamper grown from a not fully developed master substrate. The master substrate was a 80 nm ZnS—SiO₂ master. The bumps were developed to a depth of 60 nm. The bumps are well shaped and the shape is well replicated in the stamper. The problem of underetching and the subsequent dovetail connections, as also discussed above, do not appear.

### Embodiment 14

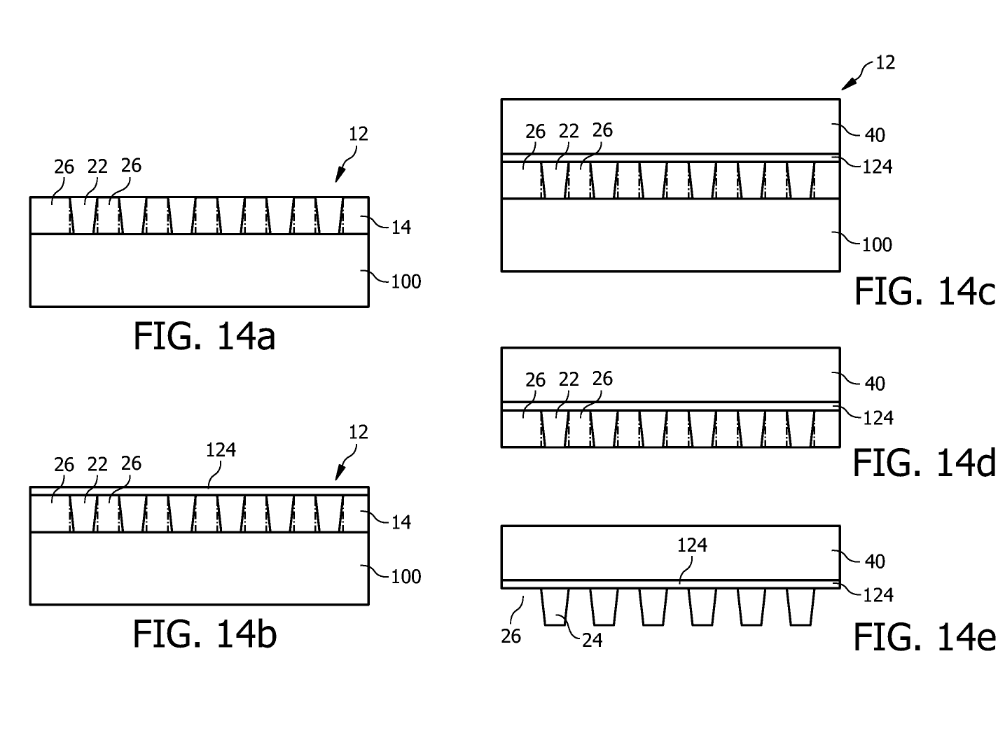

FIGS. 14a to 14e show a fourteenth embodiment of a master substrate 12 in accordance with the present invention during processing by a method in accordance with the invention, wherein FIG. 14a shows the master substrate 12 after writing, FIG. 14b shows the master substrate with a deposited Ni layer 124, FIGS. 14c to 14e show the growth and separation of a Ni stamper 40 with bump reversal. One of the possibilities to obtain a proper bump shape is bump shape reversal. Before wet etching, a stamper is grown from the exposured PTM master. The written bump structure and the stamper are separated at the ZnS—SiO₂-glass interface. Subsequently, the recorded PTM layer is developed. The resulting bump structure has the proper bump shape, directly suitable for replication or mother stamper growing.

FIG. 14a shows the master substrate 12 after the illumination process defining the written regions 22 and the unwritten regions 26 in the ZnS—SiO₂ layer 14 on the glass substrate 100. In FIG. 14b, a Ni layer 124 was sputter deposited on the dielectric layer 14. Afterwards, in FIG. 14c, a Ni stamper 40 is grown by electrochemical plating the sputter deposited Ni layer 124. In FIG. 14d, the master substrate 12 and the stamper 40 are separated at the ZnS—SiO₂ glass interface. Subsequently, the recorded PTM layer is developed (FIG. 14e).

### Embodiment 15

According to a fifteenth embodiment of the invention, the bump shape may be optimized by lowering the absorption of the PTM material. This may be achieved by modifying the ZnS—SiO₂ ratio. The default ratio is ZnS—SiO₂=80%-20% weight percentage. The proposed ratios are ZnS—SiO₂=70%-30% and ZnS—SiO₂=60%-40% weight percentage.

It should be clear that the single features of the attached claims can be combined advantageously, even if the claims do not refer back to the respective other claims. Therefore, all possible combinations of the features of the claims shall be regarded as being disclosed herewith. The same applies to features mentioned only in the description.

1. A method for providing a high density relief structure in a recording stack (10) of a master substrate (12), particularly a master substrate (12) for making a stamper for the mass-fabrication of optical discs or a master substrate for creating a stamp for micro contact printing, the method comprising the following steps:
providing a recording stack (10) comprising a dielectric layer (14) and means (16, 18; 20; 34) for supporting heat induced phase transitions within the dielectric layer (14);
causing a heat induced phase transition in regions (22) of the dielectric layer (14) where pits/bumps (24) are to be formed by applying laser pulses; and
removing the regions (22) of the dielectric layer (14), which have experienced a phase transition, by an etching process; or
removing the regions (26) of the dielectric layer (14), which have not experienced a phase transition, by an etching process.

2. The method according to claim 1, wherein the means (16, 18; 20; 34) for supporting heat induced phase transitions within the dielectric layer (14) comprise at least one absorption layer (16, 18) arranged above and/or below the dielectric layer (14).

3. The method according to claim 1, wherein the means (16, 18; 20; 34) for supporting heat induced phase transitions within the dielectric layer (14) comprise a dopant (20) doped into the dielectric layer (14).

4. The method according to claim 1, wherein the means (16, 18; 20; 34) for supporting heat induced phase transitions within the dielectric layer comprise nanocrystals (34) grown within the dielectric layer during an annealing process.

5. The method according to claim 2, wherein the absorption layer (16) is made of a material selected from the following group: Ni, Cu, GeSbTe, SnGeSb, InGeSbTe, silicide forming materials like Cu—Si or Ni—Si, material compositions like nucleation dominated phase change materials.

6. The method according to claim 1, wherein the dielectric layer (14) is a ZnS—SiO₂ layer.

7. The method according to claim 1, wherein the etchant used in the etching process is selected from the following group: acid solutions like HNO₃, HCl, H₂SO₄ or alkaline liquids like KOH, NaOH.

8. The method according to claim 2, wherein during the etching process regions (28) of the absorption layer (16) where laser pulses were applied are removed together with regions (30) of the absorption layer (16) where no laser pulses were applied.

9. The method according to claim 2, wherein during the etching process only the regions (28) of the absorption layer (16) are removed which are located above the regions (22) of the dielectric layer (14) which are removed.

10. The method according to claim 2, wherein the step of providing a recording stack (10) comprises providing a recording stack (10) further comprising a mirror layer (32) below the dielectric layer (14).

11. The method according to claim 10, wherein the mirror layer (32) is made from a material selected from the following group: Ag, Al, Si.

12. The method according to claim 1, wherein the step of providing a recording stack (10) comprises providing a recording stack (10) comprising an absorption layer (16) above the dielectric layer and a further absorption layer (18) below the dielectric layer (14).

13. The method according to claim 12, wherein the step of providing a recording stack (10) comprises providing a recording stack (10) further comprising a further dielectric layer (36) below the further absorption layer (18).

14. The method according to claim 1, wherein the step of providing a recording stack (10) comprises providing a recording stack (10) further comprising a covering layer (38).

15. The method according to claim 14, wherein the covering layer (38) is made of an etchable dielectric layer.

16. The method according to claim 3, wherein the dopant (20) is selected from the following group: N, Sb, Ge, In, Sn.

17. The method according to claim 1, wherein the step of providing a recording stack (10) comprises providing a recording stack (10) comprising a plurality of alternating dielectric layers (14, 54, 58, 62, 66, 70, 74, 78, 82, 86) and absorption layers (16, 56, 60, 64, 68, 72, 76, 80, 84, 88).

18. The method according to claim 17, wherein the plurality of alternating dielectric layers (14, 54, 58, 62, 66, 70, 74, 78, 82, 86) and absorption layers (16, 56, 60, 64, 68, 72, 76, 80, 84, 88) is formed by 2 to 20 dielectric layers and 2 to 20 absorption layers, preferably by 5 to 15 dielectric layers and 5 to 15 absorption layers, and most preferably by about 10 dielectric layers and 10 absorption layers.

19. The method according to claim 17, wherein the dielectric layers comprise a thickness between 0.5 and 20 nm, preferably between 1 and 10 nm, and most preferably of about 5 nm.

20. The method according to claim 17, wherein the absorption layers comprise a thickness between 0.1 and 10 nm, preferably between 0.2 and 5 nm, and most preferably of about 1 nm.

21. A master substrate (12) for creating a high-density relief structure, particularly a master substrate (12) for making a stamper for the mass-fabrication of optical discs or a master substrate for creating a stamp for micro contact printing, wherein for forming the high-density relief structure there is provided a dielectric layer (14) doped by a dopant (20) enhancing its absorption properties for laser pulses.

22. The master substrate according to claim 21, wherein the dopant (20) is selected from the following group: N, Sb, Ge, In, Sn.

23. A master substrate (12) for creating a high-density relief structure, particularly a master substrate (12) for making a stamper for the mass-fabrication of optical discs or a master substrate for creating a stamp for micro contact printing, wherein for forming the high-density relief structure there is provided a dielectric layer (14) containing nanocrystals (34) grown by an annealing process.

24. A method for providing a high density relief structure in a recording stack (10) of a master substrate (12), particularly a master substrate (12) for making a stamper for the mass-fabrication of optical discs or a master substrate for creating a stamp for micro contact printing, the method comprising the following steps:
providing a recording stack (10) comprising a dielectric layer (14);
causing a heat induced phase transition in regions (22) of the dielectric layer (14) where pits/bumps (24) are to be formed by applying laser pulses having a wavelength between 250 and 800 nm, particularly between 257 and 405 nm; and
removing the regions (22) of the dielectric layer (14) which have experienced a phase transition by an etching process; or
removing the regions (26) of the dielectric layer (14) which have not experienced a phase transition by an etching process.

25. The method according to claim 24, wherein the dielectric layer (14) is a ZnS—SiO₂ layer.

26. The method according to claim 25, wherein the ZnS component of the ZnS—SiO₂ layer (14) is present with less than 80% weight percentage.

27. The method according to claim 24, wherein the recording stack comprises at least one absorption layer (16).

28. The method according to claim 24, wherein after the etching process a coating (116) is applied.

29. The method according claim 24, wherein the etching process is stopped before an underetching of regions of the dielectric layer (14) that shall not be removed occurs.

30. The method according to claim 24, wherein the dielectric layer (14) comprises a first surface arranged close to the laser during the application of the laser pulses and a second surface arranged afar from the laser during the application of the laser pulses, and wherein the etching process starts on the second surface of the dielectric layer (14).

31. A method for making a stamper (40) for the mass-fabrication of optical discs (50), the method comprising the following steps:
providing a recording stack (10) comprising a dielectric layer (14) and means (16, 18; 20; 34) for supporting heat induced phase transitions within the dielectric layer (14);
causing a heat induced phase transition in regions (22) of the dielectric layer (14) where pits/bumps (24) are to be formed by applying laser pulses;
removing the regions (22) of the dielectric layer (14), which have experienced a phase transition, by an etching process; or
removing the regions (26) of the dielectric layer (14), which have not experienced a phase transition, by an etching process; and
making the stamper (40) on the basis of the recording stack (10).

32. A method for making an optical disc (50), the method comprising the following steps:
providing a recording stack (10) comprising a dielectric layer (14) and means (16, 18; 20; 34) for supporting heat induced phase transitions within the dielectric layer (14);
causing a heat induced phase transition in regions (22) of the dielectric layer (14) where pits/bumps (24) are to be formed by applying laser pulses;
removing the regions (22) of the dielectric layer (14), which have experienced a phase transition, by an etching process; or
removing the regions (26) of the dielectric layer (14), which have not experienced a phase transition, by an etching process;
making a stamper (40) on the basis of the recording stack (10); and
using the stamper (40) to make the optical disc (50).

33. A method for making a stamp (42) for micro contact printing, the method comprising the following steps:
providing a recording stack (10) comprising a dielectric layer (14) and means (16, 18; 20; 34) for supporting heat induced phase transitions within the dielectric layer (14);
causing a heat induced phase transition in regions (22) of the dielectric layer (14) where pits/bumps (24) are to be formed by applying laser pulses;
removing the regions (22) of the dielectric layer (14), which have experienced a phase transition, by an etching process; or
removing the regions (26) of the dielectric layer (14), which have not experienced a phase transition, by an etching process; and
making the stamp (42) on the basis of the recording stack (10).

34. A method for making a microprint (52), the method comprising the following steps:
providing a recording stack (10) comprising a dielectric layer (14) and means (16, 18; 20; 34) for supporting heat induced phase transitions within the dielectric layer (14);
causing a heat induced phase transition in regions (22) of the dielectric layer (14) where pits/bumps (24) are to be formed by applying laser pulses;
removing the regions (22) of the dielectric layer (14), which have experienced a phase transition, by an etching process; or
removing the regions (26) of the dielectric layer (14), which have not experienced a phase transition, by an etching process;
making a stamp on the basis of the recording stack (10); and
using the stamp (42) to make the microprint (52).

35. A method for making a stamper (40) for the mass-fabrication of optical discs (50), the method comprising the following steps:
providing a recording stack (10) comprising a dielectric layer (14);
causing a heat induced phase transition in regions (22) of the dielectric layer (14) where pits/bumps (24) are to be formed by applying laser pulses having a wavelength between 245 and 270 nm, particularly between 257 and 266 nm;
removing the regions (22) of the dielectric layer (14) which have experienced a phase transition by an etching process; or
removing the regions (26) of the dielectric layer (14) which have not experienced a phase transition by an etching process; and
making the stamper (40) on the basis of the recording stack (10).

36. A method for making an optical disc (50), the method comprising the following steps:
providing a recording stack (10) comprising a dielectric layer (14);
causing a heat induced phase transition in regions (22) of the dielectric layer (14) where pits/bumps (24) are to be formed by applying laser pulses having a wavelength between 245 and 270 nm, particularly between 257 and 266 nm;
removing the regions (22) of the dielectric layer (14) which have experienced a phase transition by an etching process; or
removing the regions (26) of the dielectric layer (14) which have not experienced a phase transition by an etching process;
making a stamper (40) on the basis of the recording stack (10); and
using the stamper (40) to make the optical disc.

37. A method for making a stamp (42) for micro contact printing, the method comprising the following steps:
providing a recording stack (10) comprising a dielectric layer (14);
causing a heat induced phase transition in regions (22) of the dielectric layer (14) where pits/bumps (24) are to be formed by applying laser pulses having a wavelength between 245 and 270 nm, particularly between 257 and 266 nm;
removing the regions (22) of the dielectric layer (14) which have experienced a phase transition by an etching process; or
removing the regions (26) of the dielectric layer (14) which have not experienced a phase transition by an etching process; and
making the stamper (40) on the basis of the recording stack (10).

38. A method for making a microprint (52), the method comprising the following steps:
providing a recording stack (10) comprising a dielectric layer (14);
causing a heat induced phase transition in regions (22) of the dielectric layer (14) where pits/bumps (24) are to be formed by applying laser pulses having a wavelength between 245 and 270 nm, particularly between 257 and 266 nm;
removing the regions (22) of the dielectric layer (14) which have experienced a phase transition by an etching process; or
removing the regions (26) of the dielectric layer (14) which have not experienced a phase transition by an etching process;
making a stamp (42) on the basis of the recording stack (10); and
using the stamp (42) to make the microprint (52).
